(19) United States
(12) Patent Application Publication
(10) Pub. No.: US 2006/0062358 A1
(43) Pub. Date: Mar. 23, 2006

(54) Method and apparatus for shared line FMFM sub-mailbox determination, dynamic out dialing and call path duplication in a telephone system

(75) Inventors: Larry B. Pearson, San Antonio, TX (US); Jeffrey Lewis Brandt, Cedar Park, TX (US); James Thomas Miller, Austin, TX (US); James M. Doherty, Georgetown, TX (US); Stephen Mark Mueller, Austin, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 10/948,424

(22) Filed: Sep. 23, 2004

(51) Int. Cl. H04M 1/64

(52) U.S. Cl. 379/88.2

(57) ABSTRACT

The present invention provides a method and apparatus for a shared line Find-Me-Follow-Me (FMFM) voicemail application. Each person sharing a telephone number is provided a sub mailbox with FMFM contact numbers individually configured for each user sub mailbox. The invention further provides a method and apparatus for dynamic out dial determination that removes numbers from the FMFM contact number list that match numbers in the inbound call path to avoid looping. The present invention further provides a method and apparatus for FMFM call path duplication of the inbound call path onto the out dial call information to provide caller identification for the original calling party after the call is forwarded or processed using FMFM.

### BACKGROUND OF THE INVENTION

1. Field of the Invention

The present invention relates to the field of telecommunications. More particularly, the present invention relates to Find-Me-Follow-Me features provided in a telephone system.

2. Background Information

Presently, a number of public switched telephone networks (PSTN) and advanced intelligent networks (AIN) enable dynamic interaction between their customers and their respective service accounts. Servers, databases, intelligent peripherals and other external data network elements interface with the PSTN/AIN to process and store information created during routine handling of telephone calls.

For example, U.S. Pat. No. 6,603,973 B 1 entitled Call Redirection System by Foladare et al. describes a telephone network arranged to give a telephone call placed to a called party's personal telephone number a particular call treatment. The call treatment is selected as a function of the particular one of a plurality of predefined areas in which the called party is determined to be located. Each of the plurality of predefined areas has at least two telephone stations with different telephone numbers located therein. The location of the called party is determined from the location of a two-way pager associated with the called party as detected by a paging antenna, e.g., tower, of a conventional two-way paging system that was not necessarily installed for use in completing telephone calls. For each personal telephone number, a table is stored associating a call treatment with one or more of the areas. The particular call treatment associated with an area is applied to calls to the personal telephone number when he is within that area.

Known Follow-Me-Find-Me (FMFM) systems allow a calling party to select an FMFM option when a subscriber does not answer the telephone. When selected FMFM calls a series of contact numbers, designated by a subscriber, to locate the subscriber when he/she does not answer the telephone. FMFM is typically associated with a single subscriber and does not support multiple users at a single telephone number.

### SUMMARY OF THE INVENTION

The present invention provides a method and apparatus for a shared line Find-Me-Follow-Me (FMFM) function in a voicemail enabled telephone system. The FMFM function (referred to as “FMFM”) runs as an application for a VoIP telephone system or directly implemented in the voice network switching infrastructure of a telephone system. A plurality of mailboxes, referred as sub mailboxes are created and assigned to a single subscriber telephone number. Each person sharing a telephone number is provided a sub mailbox with FMFM contact numbers individually configured for each user sub mailbox. The present invention further provides a method and apparatus for dynamic out dial determination that dynamically removes numbers from the FMFM contact number list that match numbers in the inbound call path to avoid looping. The present invention further provides a method and apparatus for FMFM call path duplication of the inbound call path onto the out dial call information to provide caller identification for the original calling party after the call is forwarded or processed using FMFM.

Call path duplication copies the original calling party's telephone number (when available) to the out-dialed line so that the called party and the called switching equipment see the original calling number even after the call has been forwarded. A subscriber can identify a calling party from a forwarded call without answering the telephone using caller identification. Thus, it is an aspect of the present invention to provide multiple FMFM sub mailboxes associated with a single subscriber telephone number to accommodate multiple end users at the subscriber telephone line. It is another aspect of the present invention to avoid looping and unnecessary dialing in the implementation of FMFM style services in a telephone system. It is another aspect of the invention to provide caller identification on forwarded calls to an end user of FMFM services. These and other aspects of the invention will be described in the following description and figures.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE FIGURES

For detailed understanding of the present invention, references should be made to the following detailed description of an exemplary embodiment, taken in conjunction with the accompanying drawings, in which like elements have been given like numerals.

FIG. 1 illustrates an example of a high level architectural diagram of the environment in which the present example of the invention operates;

FIG. 2 depicts an example of interaction with FMFM over the Internet, using a GUI in the present example of the invention;

FIG. 3 depicts an example of interaction with FMFM over an Telephone User Interface (TUI) application for providing an Interactive Voice Response (IVR) system, using a DTMF telephone in the present example of the invention;

FIG. 4 illustrates an example of an FMFM configuration access screen available to a user via a graphical user interface (GUI) in the present example of the invention;

FIG. 5 illustrates an example of the functions performed by FMFM to select a mailbox to assign FMFM settings in the present example of the invention;

FIG. 6 illustrates an example of an FMFM configuration access screen available to a user via a graphical user interface (GUI);

FIG. 7 illustrates an example of flow the entry of FMFM settings through a telephone user interface (TUI) in the present example of the invention;

FIG. 8 illustrates an example of flow for the entry of FMFM settings to enable/disable FMFM for a mailbox through a TUI in the present example of the invention;

FIG. 9 illustrates an example of entry of FMFM settings to activate FMFM for All Callers or Key Contact List Only for a mailbox through a TUI in the present example of the invention;

FIG. 10 illustrates an example of entry of FMFM settings to enter FMFM contact numbers for a subscriber sub mailbox through a TUI in the present example of the invention;

FIG. 11 illustrates an example of flow for the entry of FMFM settings to enter FMFM contact numbers for a subscriber sub mailbox through a TUI in the present example of the invention;

FIG. 12 illustrates an example of flow for the entry of FMFM settings to enter a number of rings for an FMFM contact number through a TUI in the present example of the invention;

FIG. 13 illustrates an example of flow for the entry of FMFM settings to enter a number of rings for an FMFM contact number through a TUI in one aspect of the present invention;

FIG. 14 illustrates an example of flow for the entry of FMFM settings to announce a greeting to a calling party associated with a sub mailbox through a TUI in the present example of the invention;

FIG. 15 illustrates an example of flow for the entry of FMFM settings to check for FMFM active on all calls or key contacts only and to skip contact numbers that appear in the inbound call path as a redirecting number or a calling party number in the present example of the invention;

FIG. 16 illustrates an example of flow for the entry of FMFM settings to prompt a calling party to leave a voice message in voice mail in the present example of the invention;

FIG. 17 illustrates an example of flow for the entry of FMFM settings to skip contact numbers that appear in the inbound call path as a redirecting number or a calling party number in one aspect of the present invention;

FIG. 18 illustrates that when the out dial call leg accepts the call, that the two calls, the inbound calling party call and the outbound contact number call are connected together;

FIG. 19 illustrates an example of flow for out dialing and the insertion of the calling number for the originating call into the calling number field for an outbound call in the present example of the invention;

FIG. 20 illustrates an example of flow for the bridging together the inbound and outbound call in one aspect of the present invention;

FIG. 21 illustrates an example of flow of call information comprising a calling number and a called number between a calling party SSP and a subscriber SSP in one example of the present invention;

FIG. 22 illustrates an example of flow of call information and insertion of the original calling number as the calling number from the subscriber SSP and insertion of the called number (subscriber telephone number) as the redirecting number into calling information between a subscriber SSP and an SSP associated with a Unified Communications (UC) Platform in one example of the present invention;

FIG. 23 illustrates an example of a Follow-Me-Find-Me Service (FMFM) checking to see if FMFM is enabled for the subscriber number which has been inserted in the call information as the redirecting number of the call forwarded from the subscriber SSP to the UC SSP;

FIG. 24 illustrates an example of an announcement made to a calling party in one example of the invention in which the calling party hears the subscriber's greeting and has the opportunity to leave a voice message;

FIG. 25 illustrates an example of call information flow from the FMFM at the UC to an FMFM subscriber contact number showing the call information sent from an SSP associated with the UC to an SSP associated with the contact number, wherein the call information comprises the original or initiating calling number inserted as the calling number from the FMFM service on the UC, the contact number is inserted as the called number and the subscriber number is inserted as the redirecting number in an example of the present invention;

FIG. 26 illustrates an example of call information flow from the FMFM at the UC to an FMFM subscriber contact number wherein the call to the contact number maintains the context of the original call from the calling party to the subscriber, showing the call information sent from an SSP associated with the UC to an SSP associated with the contact number, wherein the call information comprises the original calling number inserted as the calling number from the FMFM at the UC, the contact number inserted as the called number and the subscriber number inserted as the redirecting number in an example of the present invention;

FIG. 27 illustrates an example of a called party accepting a call and bridging an inbound call to a outbound call in an example of the present invention;

FIG. 28 illustrates an example of bridging an inbound call leg to a outbound call leg within the UC Voice Over Internet Protocol (VoIP) gateways in an example of the present invention; and

FIG. 29 illustrates an example of bridging an inbound call to a outbound call using 2B channel transfer on the local serving office providing PRI service to the UC platform's VoIP gateway in an example of the present invention.

### DETAILED DESCRIPTION OF THE PREFERRED EMBODIMENTS

In view of the above, the present invention through one or more of its various aspects and/or embodiments is presented to accomplish one or more objectives and advantages, such as those noted below.

The Find-Me-Follow-Me function (FMFM) is a feature added to voicemail and IVR systems as well as directly implemented in the voice network switching infrastructure such as an FMFM or Single Number Reach (SNR) application in a PSTN, VoIP or AIN telephone system. When a caller calls an FMFM subscriber's telephone number and the number is busy or is not answered, the call is forwarded to a Unified Communication (UC) platform where the FMFM features of the present invention are implemented. The telephony portions of the FMFM reside in a Telephone User Interface (TUI) and the subscriber interface and screen functions reside in the Web Server. Assuming that the subscriber has FMFM activated, the caller will be given the opportunity to go straight to voicemail to leave a message or wait while the FMFM system at the UC platform calls subscriber designated contact telephone numbers in an attempt to find the subscriber.

The present example of the invention provides enhanced FMFM features such as sub mailbox determination, call path duplication, and dynamic out dial as improvements to an FMFM service. In the past, services such as FMFM and Single Number Reach (SNR) have been associated with a single end-user (subscriber) at a single telephone number. That is, in the past, multiple end-users per telephone number were not supported by FMFM or SNR. SNR is similar to FMFM in terms of what the caller hears once the service is activated. The difference is, FMFM is tied to the subscriber's voicemail service and SNR has a special telephone number for callers to call. An SNR customer will give out their SNR number instead of the home number or wireless number. FMFM customers provide telephone numbers where they might answer the telephone such as their home, office, or wireless telephone numbers. The improvements described herein are applicable to all call forwarding applications, including but not limited to FMFM and SNR. The present example discusses the improvements provided by the present invention in the context of an FMFM service. The present invention, however, is not limited to FMFM, voice mail or Unified Messaging Service applications.

Prior FMFM and SNR implementations generally worked as follows: A caller called an FMFM subscriber. FMFM asked the caller to speak their name after a beep or hit 1 for FMFM or otherwise go to voicemail. If requested by the caller, FMFM called the FMFM contact number(s). When a party at a contact number answered, FMFM asked the called party if they wished to accept a call from a “calling party name.” The called party either accepted the call or allowed it to go voicemail without being accepted. This prior FMFM and SNR scheme worked well when there is only one person associated with the dialed telephone number. However, FMFM and SNR did not work for more than one person at the telephone number.

Thus, prior FMFM systems had an inherent disadvantage. Taken in the context of families, individual family members could not fully utilize FMFM as a feature on their voicemail. There was no way to provide individual FMFM contact numbers for each family member. For example, mom and dad probably had different wireless numbers they wanted to designate as a contact number. They could not use separate contact numbers using a prior FMFM system.

The present example of the invention provides an improvement over prior FMFM systems by providing separate mailboxes (sub mailboxes) containing individual contact numbers for each family member at a single home telephone number. A plurality of mailboxes, referred to as a group mailbox is assigned to the family telephone number. Each of the mailboxes, referred to as sub mailboxes is assigned to an individual family member, with associated contact numbers. The FMFM service provided in the present example of the invention allows each family member to have their own mailbox with their own FMFM contact number(s) and FMFM settings configured within their sub mail box. Each family member can configure their own FMFM settings, such as FMFM enable, Key Contact List (KCL), contact phone numbers and number of rings. Selection, editing, utilization and storage of the FMFM settings is discussed below.

For example, a typical family household contains two parents and two children. A caller dialing the family home telephone number would expect to get one of the four family members. Configuring an FMFM service with a group mailbox and sub mailboxes directs all calls through an individualized FMFM sequence design by the user for whom the call was intended.

In an FMFM sub mailbox scenario, in the present example of the invention, a caller calls the family home number. The home number is busy or rings without answering. The caller is forwarded to FMFM. In the context of the present example, FMFM refers to an FMFM enabled service or system. The caller will hear a special greeting: “To leave a message for <person #1>, press 1. To leave a message for <person #2>, press 2. To leave a message for <person #3>, press 3. To leave a message for <person #4>, press 4.” Thus, each FMFM user has their individually configured FMFM service with individual contact numbers and voice mail greetings associated with the user's sub mailbox. The user sub mailbox is determined by a caller selection process, before the FMFM out dial service is accessed. Thus one aspect of the present invention is the provision of sub mailboxes for use by multiple FMFM users at a single telephone number.

Another aspect of the present invention is call path duplication. Call path duplication preserves the original calling party telephone number after the call has been forwarded to subsequent telephones. The original calling party is identified in the inbound call path as the caller in the initial call to the FMFM subscriber. That is, the telephone number from which the call initiated is preserved and passed along with the call as the call is forwarded to the UC and subsequent contact numbers. The subsequent forwarding telephones are listed as redirecting numbers in subsequent calls while the original calling party number is inserted the calling party number in subsequent calls. Call path duplication enables a called party to identify the caller through caller identification before answering the telephone.

The present example of the invention provides call path duplication as an improvement to prior FMFM and SNR services which have relied on a challenge response system to determine and communicate the caller's identity to a subscriber. This provides an improvement over the challenge response method of caller identification where a caller is asked to speak their name, which is repeated to a called party when answering the telephone. At a high level, prior FMFM and SNR implementations performed the following challenge response functions: Ask a calling party to speak their name after a beep or hit 1 to go directly to voicemail. When the caller speaks their name, the system recorded it for playback to the FMFM subscriber. The system then called each contact number in order. When one of the FMFM contact numbers was answered by the subscriber, the system asked the called party if they wished to accept a call from “calling party name.” The recording of the caller's name was then played back for the called party. The called party then either hit a 1 to accept the call or sent it to voicemail without accepting it.

Thus, the prior challenge response FMFM implementation could give the caller the feeling they were being screened and also forced the called party to answer the phone to see who was calling and decide if they wanted to take the call. The present example of invention provides call path duplication, which eliminates the experience of recording, replaying and approving a calling party name.

In another aspect of the invention call path duplication copies the inbound call path (or portions of it) into the outbound call path information for a outbound call. That is, on forwarding a call or for each out dial call that FMFM makes to contact a subscriber, the original call initiating telephone number (when available) and each Redirecting Number (RDN) from which the call was forwarded, are duplicated and inserted on the out dialed calling information line. Thus the called party and the called party's switching equipment see the same calling party calling information that the FMFM service saw on the original call, except that the called number has changed. This keeps the original calling party's telephone number available for caller identification by the FMFM subscriber.

The call path duplication aspect of the present invention improves prior systems. Call path duplication speeds up the approval and connection time between a calling party and a called party. Also, a subscriber can identify an incoming call by glancing at a caller identification number and name when available, without answering the telephone and listening to a recorded name announcement. Thus, call path duplication provides a better experience for both the subscriber called party and the calling party in a call forwarding and FMFM scenario.

Another aspect of the present invention provides a dynamic out dial feature. Dynamic out dial skips telephone numbers appearing on an FMFM or SNR out dial contact number list that have already been tried. Dynamic out dial provides a better caller and subscriber experience by providing quicker connection time by eliminating looping and futile retries of FMFM contact numbers Dynamic out dial skips contact numbers that appear in an inbound calling path as an RDN or as a calling party number (CN).

The dynamic out dial FMFM feature also lowers service provider costs by lowering the number of out dials made on system equipment. Dynamic out dial speeds up the connection time between the caller and called party by skipping contact numbers which have been tried or are known to be busy. Dynamic out dial also results in fewer calls being abandoned because caller wait times are reduced, thereby providing a better subscriber experience. The dynamic out dial feature of the present invention dynamically adapts to each call scenario to provide the best out dial choice possible.

Dynamic out dial also minimizes the potential for looping with-in FMFM and call forwarding services, thereby lowering the potential for adverse feature interaction. The looping problem occurred in prior FMFM systems as follows. Prior FMFM systems called a list of one or more out dial contact numbers to reach a called party on behalf of a calling party. When FMFM was tied into call forwarding arrangements, call-looping problems could occur between phone numbers using each other as an FMFM contact number or call forwarding number (CFN). The following loop example illustrates the problem. A caller calls “Bob” at work. Bob is out of the office and has all of his work calls forwarded to his wireless telephone number. Bob is busy talking on his wireless phone so the wireless network forwards the call to a network voicemail system that supports FMFM. Bob has configured his FMFM service to call him at the following FMFM contact telephone numbers, in the following order: Wireless Phone; Office Phone; and Home Phone.

The FMFM service will dial Bob's wireless phone number first. The wireless phone will not be answered because Bob is busy talking on it. The FMFM system will forward the call from the wireless number to voicemail where it will activate (again) the FMFM service. The FMFM system will then try the next contact number, Bob's office phone. Bob's office phone is forwarded to the wireless phone. After forwarding, the call will end up back into the wireless phone's voicemail where it will reactivate the FMFM service. Next the system will try the home phone.

In this example, the caller's telephone number, Bob's office number, and Bob's wireless number are in the inbound call path for the voice mailbox. Numerous FMFM and SNR implementations avoid the looping problem outlined above by not allowing the voice mailbox number to be one of the numbers used to find the subscriber. However, given that integrated wireless and wire line voice mailboxes have become available in the past few years, the solution of disallowing mailbox numbers from the FMFM dialed number list potentially reduces value of the FMFM service.

Looping, as described above, is eliminated by the dynamic out dial feature provided by the present invention. Dynamic out dial removes numbers from the out dial list that match numbers that are in the inbound call path. Numbers that appear in the inbound call path have already been tried and not answered or are known to be busy. Notice the inbound call path in the above example contained looping problem numbers.

The dynamic out dialing feature of the present invention eliminates the looping problem by removing the inbound call path numbers from the list of FMFM contact numbers, which removes looping from the prior example to the following scenario: A caller calls “Bob” at work. Bob is out of the office and has all of his calls forwarded to a call forwarding number (CFN), his wireless number. Bob is busy talking on his wireless phone so the wireless network forwards the call to a voicemail system that supports dynamic out dial FMFM.

Bob has configured his FMFM service having dynamic out dial to try him at the following contact numbers telephones in order: Wireless Phone; Office Phone; and Home Phone. In the prior example, without dynamic out dial, the FMFM service would have dialed Bob's wireless phone number first. However, Bob's wireless phone is the last RDN and therefore appears in the inbound call path. When a number appears in the inbound call path, there is no reason to try it again as it has already been tried and was not be answered or is the calling party so the line is occupied. Thus, the dynamic out dial skips the wireless number as it is in the inbound call path.

FMFM without dynamic out dial would have tried Bob's office phone next. Since the office phone is the first RDN, it appears in the inbound call path. Dynamic out dial determines, since the office phone is in the inbound call path as an RDN, that the system has already tried the office phone number and found that Bob did not answer. The dynamic out dial feature uses this information and skips the office phone number and goes on to the next number in the out dial list. Next dynamic out dial will try the home phone, since the home phone is not in the inbound call path.

In the above dynamic out dial scenario, the calling number and any of the redirecting numbers are in the call path. If we change the dynamic out dial FMFM example above to where Bob's wife is calling Bob from their home number, then all possible contact numbers will be in the inbound call path. The dynamic out dial feature determines that all of the contact numbers are in the inbound call path, have already been tried or are in use and will send the calling party call directly to voicemail.

Another FMFM option is to connect the calling and called party connected together when the called party answered the call, so that the called party does not have to listen to a message, i.e. caller's name, or press a digit to accept the call. This option may not be desirable as there is a significant chance, however, that the called number will end up terminating on an answering machine or call answering service such as voicemail. When the call terminates on an answering service, the FMFM service should continue trying the next number in the contact number list or send the caller (if at the end of the list) to voicemail. Thus, pressing a digit to accept a call is an available option, even with the provision of call path duplication.

The call path duplication FMFM feature of the present invention preserves the initiating calling party's Caller identification information on the out dialed call. The called party can accept or reject the call based on the Caller identification information. FMFM with call path duplication activates after the subscriber sub mailbox has been identified. This makes the call path duplication FMFM feature compatible with Group Mailboxes. That is, if the mailbox is a group mailbox, the caller selects the individual mailbox they wish to contact or leave a message. Once the caller has selected a sub mailbox, if FMFM is activated, FMFM will call the contact numbers associated with that specific sub mailbox.

Another aspect of the present invention provides a system for implementing an FMFM service that includes a unified communication (UC) platform, which processes telephone calls from a public switched telecommunications network (PSTN), an interactive voice response (IVR) system provided by a Telephone User Interface (TUI) and a graphic user interface (GUI). The UC platform includes a database of FMFM settings that corresponds to the subscriber telephone number. The IVR system is accessible by the subscriber from any dual tone multi-frequency telephone through a PSTN.

The subscriber receives the FMFM settings for review via GUI or TUI and adjusts the FMFM settings to control the FMFM service using either the Dual Tone Multiple Frequency (DTMF) telephone and IVR or the GUI. The UC platform receives the FMFM settings from the subscriber, from either the dual tone multi-frequency telephone or the graphical user interface, and communicates the FMFM service to a Master Directory Sever (MDS), which updates the FMFM settings. The UC platform then processes calls to the telephone number of the subscriber in accordance with the updated FMFM settings. A separate set of FMFM settings are associated with each sub mailbox associated with the subscriber telephone number.

Another aspect of the invention provides a system for implementing an FMFM that includes a UC platform, which processes telephone calls in a Voice Over Internet Protocol (VoIP) telephone network. The UC platform provides the MDS, an LDAP Server for storage of FMFM settings for sub mailboxes corresponding to a subscriber's telephone number.

The UC platform also includes a Web server, through which the FMFM subscriber receives at a GUI the FMFM settings and updates FMFM settings through a packet switched data network. There is also an TUI implementation of an IVR through which the subscriber receives at a dual tone multi-frequency telephone the FMFM settings to update the FMFM service through the public switched telecommunications network.

The FMFM settings updates can include but are not limited to FMFM contact numbers, assigning sub mailboxes, setting ring counts and setting greetings for each sub mailbox. FMFM updates the subscriber's FMFM settings in accordance with the user's input. FMFM running at the UC platform then processes incoming calls to the subscriber's telephone number in accordance with the updated FMFM settings.

In another aspect of the present invention, the FMFM settings also include a Key Contact List (KCL), which contains at least one telephone number. A subscriber or user can create and edit the KCL. The address book of incoming and outgoing telephone numbers can also be added to the KCL. If the KCL only option is turned on, whenever a call is placed from a telephone number which appears on the KCL to the subscriber's telephone number, the call is selectively processed by the FMFM. The selective processing includes forwarding the KCL call to a contact number, while a call from a telephone number not on the KCL is not forwarded. Alternatively, a non-KCL call may be forwarded to a contact number, if all calls active is selected to activate the FMFM service.

The subscriber receives the FMFM settings and sends KCL instructions to control the KCL from the graphical user interface by way of the Web server. The KCL control instructions can include adding a new telephone number to the KCL and removing one of the KCL telephone numbers from the priority screening list. The FMFM platform then updates the KCL in accordance with the KCL instructions and processes calls to the subscriber's telephone number of the subscriber in accordance with the updated FMFM settings.

Another aspect of the present invention provides for a method of implementing a dynamic out dialing service. The method includes removing numbers from an FMFM out dial list of contact numbers that appear in an inbound call path as a calling party number or as a redirecting number.

Another aspect of the present invention provides for a method of implementing call path duplication. The method includes receiving a call from a first telephone at a second telephone, the call having a calling party number associated with the first telephone and forwarding the call to a third telephone number. The call forwarded has the calling party number for the first telephone inserted as the calling party telephone number in the call from the second telephone to the third telephone.

The following is a brief discussion of a Public Switched Telephone Network (PSTN) and a Voice over Internet Protocol Telephone System which will aid an understanding the invention.

There are four major tasks performed by the PSTN to connect a call. While the PSTN is capable of providing other services beyond point-to-point voice calls such services are predicated upon the following basic tasks: (1) signaling; (2) database services; (3) call set-up and tear-down; and (4) analog voice to digital data conversion.

Phones calls are inherently connection oriented. That is, a connection to the called entity must be established ahead of time before a conversation can occur. Switches, the central components in the PSTN, are responsible for creating this connection. Between the circuit switches are connections (trunk lines) that carry the voice traffic. These links vary in data communication speed from T-1 and E-1 to OC-192/STM-64, with individual channels (DS-Os) in each link type representing one voice channel. Switches are also responsible for converting the analog voice signal into a digital data format that may be transported across the network.

Signaling notifies both the network and its users of important events. Examples of signaling range from telephone ringer activation to the dialing of digits used to identify a called entity. Network elements also use signaling to create connections through the network. The Signaling System Seven (SS7) is a standard, packet-based network that transports signaling traffic between the switches involved in the call.

A call begins when a user dials a destination phone number using call origination equipment. A local switch typically analyses the destination number to determine if the call is a local one. If the call is local, the local switch may directly connect the call. More typically, the dialed telephone number results in a query to one or more service control points (SCP). SCPs are databases that execute queries and translate the dialed telephone phone numbers into a set of circuit switching commands. SCPs also allow such common telephone features as 800 number support, 911 service, and caller identification. Signaling switch points (SSP) are the interface between switches and the SS7 network. It is here that SS7 messages are translated into the connection details required by the switches to physically connect the call origination point to the call destination point.

The SS7 control network is “out of band,” that is, it is not transmitted within the same links used to carry the actual voice channels. Specialized equipment called Signal Transfer Points (STPs) transport the SS7 signaling messages. As will be seen hereafter, these STPs are analogous to IP routers in that the messages are carried in data packets called message transfer parts.

Like the PSTN, components forming a VoIP network must perform four basic functions: (1) signaling; (2) database services; (3) call connection and disconnection (bearer control); and (4) Coder/decoder (CODEC) operations. An IP backbone provides connectivity amongst a great number of distributed elements. The IP Backbone can be viewed as one logical switch. The logical switch is, however, a distributed system. Depending on the VoIP protocols used, this system as a whole is sometimes referred to as a soft switch architecture.

Signaling in a VoIP network is just as critical as it is in the legacy phone system. The signaling in a VoIP network activates and coordinates the various components to complete a call. Although the underlying nature of the signaling is the same, there are some technical and architectural differences.

Signaling in a VoIP network is accomplished by the exchange of IP datagram messages between network components. The format for these messages is covered by a number of standards, or protocols. Regardless of the protocol or hardware components used, the messages are critical to the function of a voice-enabled IP network and need special treatment to guarantee their delivery across the IP backbone.

Among other functions, database services are a way of locating an endpoint and translating an address communicated between two (usually heterogenous) networks linked by the VoIP backbone. For example, the PSTN uses phone numbers to identify endpoints, while a VoIP network might use a Universal Resource Locator (URL) or an IP address with port numbers to identify an endpoint. A call control database contains the necessary mappings and translations to identify endpoints. Functionally similar to call state and call control in the PSTN, “session state” in a VoIP network defines the nature of the call and controls the activities of components in the network.

The connection of a call in a VoIP network is made by two endpoints opening a communication session between each other. In the PSTN, the public (or private) switch connects logical DS-0 channels through the network to complete a call. In a VoIP implementation, this connection can be a multimedia stream (audio, video, or both) transported in real time between endpoints. This connection is referred to as the bearer (or payload) channel and represents the voice or video content being delivered. When communication is complete, the IP session is ended and network resources are released.

As already noted, voice communication is analog, while data networking requires digital data. The process of converting analog voice into digital data is done by a coder-decoder (CODEC). There are many well known ways to convert analog voice into digital data. The processes used to convert, compress, and otherwise manipulate voice data in digital form are numerous and complex. Most are governed by publicly available standards.

The major components of a VoIP network are similar in functionality to the components forming a circuit-switched network. VoIP networks must perform all of the same tasks performed by the PSTN, in addition to providing a gateway between the VoIP network and the existing PSTN. Although using different technologies and approaches, some of the same component concepts that make up the PSTN are found in VoIP networks. There are three general components forming a VoIP network: (1) gateways; (2) gateway controllers or gate keepers; and (3) the IP backbone.

Gateways are responsible for call origination, call detection, and CODEC functions, including at least analog-to-digital conversion and voice packet creation. In addition, gateways have optional features, such as data compression, echo cancellation, silence suppression, and statistics gathering. Gateways form the interface allowing voice data to be transported across the IP network. In other words, gateways are the source of bearer traffic. Typically, each call is a single IP session transported by a Real Time Transport Protocol (RTP) that runs over a User Datagram Protocol (UDP). Media gateways exist in several forms, ranging from a dedicated telecommunication equipment chassis to a generic PC running VoIP software.

Gateway controllers or gate keepers house the signaling and control services that coordinate the gateway functions. Gateway controllers are responsible for call signaling coordination, phone number translations, host lookup, resources management, and signaling gateway services to the PSTN.

The IP infrastructure must ensure smooth delivery of the voice and signaling packets to the VoIP components. Due to their dissimilarities, the IP network must treat voice and data traffic differently. That is, voice and data traffic require different transport handling consideration and prioritization.

While there is correlation between VoIP and circuit-switching components, there are also many significant differences. One difference is found in the transport of voice traffic. Circuit-switching telecommunications can best be described as a Time-Division-Multiplexing (TDM) network that dedicates channels or reserves bandwidth as it is needed out of the trunk lines interconnecting an array of switches. For example, each phone call reserves a single DS-0 channel, and an associated end-to-end connection is formed to enable the call.

SS7 has been previously referenced in the discussion of the PSTN. The SS7 signaling protocol is implemented as a packet-switched network. SS7 is both a protocol and a network designed to signal voice services. SS7 is a unified interface for the establishment of circuit-switching, translation, and billing services.

SS7 is not built on top of other protocols. Rather, it is completely its own protocol suite from physical layer to application layer. For networks transporting SS7, it is important that these services be either translated or tunneled through the IP network reliably. Given the importance of SS7 signaling, it is necessary to ensure that these messages are given priority in the network. VoIP networks often require access to the SS7 facilities in order to bridge calls onto the PSTN.

ITU recommendation H.323 specifies a packet-based multimedia communication system. The specification defines various signaling functions, as well as media formats related to packetized audio and video services. H.323 standards were generally the first to classify and solve multimedia delivery issues over Local Area Networks (LAN) technologies. However, as IP networking and the Internet became prevalent, many Internet RFC standard protocols and technologies were developed and sometimes based on H.323 ideas. H.323 networks consist of media gateways and gatekeepers. Gateways serve as both H.323 termination endpoints and interfaces with non-H.323 networks, such as the PSTN. Gatekeepers function as a central unit for call admission control, bandwidth management, and call signaling. A gatekeeper and all its managed gateways form a H.323 “zone.” Although the gatekeeper is not a required element in H.323, it can help H.323 networks to scale to a larger size by separating call control and management functions from the gateways.

With each call initiated, a first TCP session is created using a first protocol defining a set of messages. A TCP connection is maintained throughout the duration of the call. A second session is established using another protocol. This TCP-based process allows an exchange of capabilities, master-slave determination, and the establishment and release of media streams. The H.323 quality of service (QoS) delivery mechanism is the Resources Reservation Protocol (RSVP).

The Real-Time Transport Protocol (RTP) protocol provides end-to-end delivery services for data with real-time characteristics, such as interactive audio and video. Services include payload type identification, sequence numbering, time stamping, and delivery monitoring. Further, the RTP protocol provides features for real-time applications, including timing reconstruction, loss detection, content delivery, and identification of encoding schemes. Many gateways that digitize voice applications use RTP to deliver the voice traffic. For each session participant, a particular pair of destination IP addresses defines the session in order to facilitate a single RTP session for each call.

RTP is an application service built on UDP, so it is connectionless with best-effort delivery. Although RTP is connectionless, it does have a sequencing system that allows for the detection of missing packets. As part of its specification, the RTP identifies the encoding scheme used by the media gateway to digitize voice content. With different types of encoding schemes and packet creation rates, RTP packets can vary in size and interval. The combined parameters of a RTP session dictate how much bandwidth is consumed by the voice bearer traffic. RTP transporting voice traffic is the single biggest data contributor to conventional VoIP traffic.

The Media Gateway Control Protocol (MGCP) (like its predecessor SGCP) largely defines the contemporary soft switch architecture. It is a master-slave control protocol the coordinates the action of media gateways. In effect, the MGCP divides the functional role of traditional voice switches between the media gateway and the media gateway controller.

In MGCP nomenclature, the media gateway controller is often referred to as a “call agent.” The call agent manages the call-related signaling control intelligence, while the media gateway informs the call agent of service events. The call agent instructs the media gateway to setup and tear-down connections when calls are generated. In most cases, the call agent informs the media gateway to start an RTP session between two endpoints.

A number of routine MGCP functions are executed during a call. A call begins when a user picks up the origination phone and dials a destination number. The gateway then notifies the gateway controller (call agent) that a call is incoming. The gateway controller looks up the dialed phone number and directs the media gateways to create a RTP connection (i.e., it identifies an IP address and port number). The gateway controller also informs the destination media gateway of the incoming call, and the destination phone rings. Thereafter, media gateways and open an RTP session across the IP network when destination phone is answered.

The following discussion will provide further description of an exemplary embodiment of the invention.

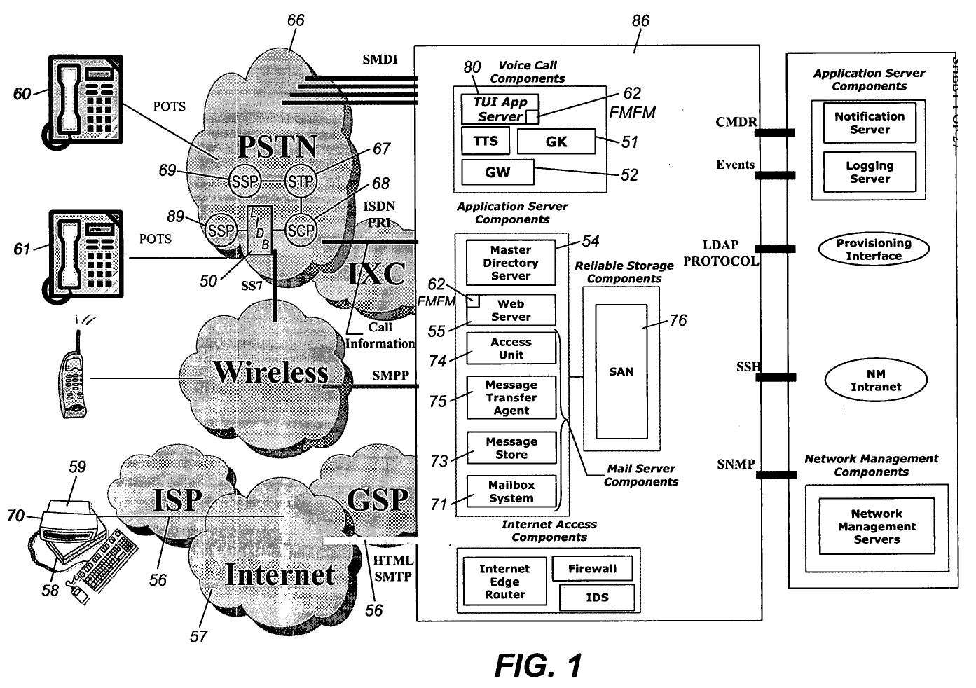

Turning now to FIG. 1, FIG. 1 illustrates a high level architectural diagram of the environment in which the present invention operates. The main components of the environment in which the present example of the invention resides comprises a public switched telephone network (PSTN) 50, Voice Over Internet Protocol (VoIP) Gateway 52, a Gatekeeper 51, TUI Application Server 80 which performs as a Gate Server, MDS 54, Web Server 55, HTML link 56, Internet 57, mail box system 71, and Web Client 70.

A calling party telephone 60 and a called party subscriber telephone 61 are shown associated with the PSTN 66 of the architectural schematic of FIG. 1. The PSTN comprises at least one Signal Transfer Point (STP) 67, Signal Service Point (SSP) 69 and Service Control Point (SCP) 68 and database components are well known in the art. The FMFM 62 function (FMFM), which is embedded in the TUI Application Server 80 provides the Sub-Mailbox, Dynamic Out Dial and Call Path Duplication features of the present invention described herein and runs on a Sun/Solaris platform at the UC platform 86. FMFM and TUI are used interchangeably in the discussion of execution of FMFM functions.

The Gatekeeper (GK) 51 determines where calls coming from the Voice over IP Gateway 52 should be routed. The Voice over IP Gateway (VoIP GW) 52 provides the bridge between the PSTN and the VoIP systems. A Telephone User Interface (TUI) is provided for the FMFM inside of the TUI Application Server 80. The TUI runs as a Logica CMG uOne application and is implemented on a Sun/Solaris or PC/Linux platform. The TUI provides a Text-To-Speech Server that converts text provided by the TUI into speech that is played over the telephone. The Web Server 55 provides web pages formulated from MDS 54 content for user input for configuration of the FMFM settings described below. Subscribers use a browser, such as Internet Explorer (IE) or Netscape browser to access mail services over the web. The web server also provides subscribers with administrative capabilities such as setting up and configuring their FMFM account or changing their password in the FMFM settings. The software is provided by DCL and implemented on a Sun/Solaris or PC/Linux platform.

The Master Directory Server (MDS) 54 implemented as a Lightweight Directory Access Protocol (LDAP) Server provides storage for FMFM settings such as service class, password, preferences, address book, configuration, phone numbers, contact numbers, FMFM enabled/disabled, number of rings, sub mailboxes, key contact list, etc. which are all stored in the MDS. Other components that use the MDS are “directory enabled.” FMFM, the Gate Server (TUI Application Server) and Web Server components all use the MDS.

A mail server 71 is provided comprising Access Unit 74, Message Transfer Agent 75 and Message Store 73. The Web Server and the TUI App Servers use the AU to retrieve message inventories and messages from the Message Store. The software for the AU is provided by Data Connections Limited (DCL) running on a Sun/Solaris or PC/Linux platform. Internet mail servers including the Web Server 55 and the TUI Server 80 use the MTA to send mail. If the mail is to be delivered to the UC platform, the MTA uses the Message Store to store the message in the subscriber's mailbox. The MTA also manages inbound and outbound mail to the Internet. The Storage Area Network (SAN) 76 provides reliable disk storage for use by the MDS and Message Store. The SAN is implemented on EMC hardware and software.

The MS 73 provides storage for the UC platform 86. The Mail Server through the AU and the MTA provides Web Servers and the TUI APP Servers with storage to store or retrieve messages. The Message Store holds voice messages, emails, facsimiles, voicemail greetings and voicemail name announcements. Software for the MS is provided by DCL running on a Sun/Solaris and EMC platform.

The following FMFM function features provide an enhanced end-user experience. The end user experience description that follows, as provided by the present invention contains: a Graphic User Interface (GUI) setup pages; Telephone User Interface (TUI) setup call flows; and FMFM network call flows as implemented by functions executed on the UC platform in the TUI Application Server and Web Server by the embedded FMFM function in the present example of the invention.

An underlying telephone system, such as a PSTN incorporates Advanced Intelligent Network (AIN) architecture that uses data bases stored in SCPs to facilitate call processing, call routing, and network management, thus allowing carriers to change the routing of both inbound and outbound calls from moment to moment. Call processing is that sequence of operations performed by the switches in the PSTN for acceptance of an incoming call through the final disposition of the call. Call routing is the process of determining and prescribing the path within the PSTN for establishing telephone connections or forwarding messages within the PSTN.

The PSTN/AIN launches a trigger from an SSP to an SCP when a telephone call is detected. By way of example, the SCP may be implemented with the Bellcore Integrated Service Control Point, loaded with ISCP software Version 4.4 (or higher), available from Telecordia, Murray Hill, N.J.

In the present example of the invention, an SSP in an originating Central Office (CO) for the caller telephone 60 sends caller information to an SSP in a terminating CO for the subscriber telephone 61. However, the terminating CO and the originating CO may be the same, or there may be any number of intervening switches routing the connection between the caller telephone 60 and the called party subscriber telephone 61. The SSP includes, for example, 1AESS or 5ESS switches manufactured by Lucent Technologies, Inc., or DMS-100 switches manufactured by Nortel Networks Corporation (Nortel), or AXE-10 switches manufactured by Telefonaktiebolaget LM Ericsson.

The 1AESS switches may use an AIN Release 0.1 protocol and should be equipped with Generic 1AE13.01 (or higher) software and associated AIN SSP features. The 5ESS switches may utilize an AIN Release 0.1 protocol and should be equipped with Generic 5E12 (or higher) software and associated AIN SSP features. The DMS-100 switches (release NA009) may utilize an AIN Release 0.1 protocol and associated AIN SSP features. The AXE-10 switches may utilize an AIN Release 0.1 protocol and should be equipped with Generic 8.07 (or higher) software and associated AIN SSP features. The call service logic of the present invention may be upgraded to accommodate future AIN releases and protocols and future trigger types. Specifications of AIN Release 0.1 SSPs may be found in Bellcore TR-NWT-001285, Switch-Service Control Point Application Protocol Interface Generic Requirements, the disclosure of which is expressly incorporated by reference herein in its entirety.

In the present example of the invention, an incoming call, from a calling party to the subscriber's telephone number, is received at a terminating SSP. The SSP forwards the call to the UC platform. The SSP switch forwards the call using a “Call Forward Busy/Don't Answer” function in the SSP.

FIG. 1 illustrates an exemplary telecommunications network in association with the present invention, for implementing FMFM. The network includes a calling party 60, an originating service switching point (SSP) 69, a terminating SSP 89 and a subscriber's telephone 61 (i.e., the call destination or the called party). The network also includes a signaling transfer point (STP) 67, a service control point (SCP) 68, TUI Application Server (also referred to as a Gate Server) and a UC platform 86. The network also provides a name database 50 connected to the SCP 68, which can be, for example a line information database (LIDB).

By way of example, the SCP 68 is implemented with the Bellcore Integrated Service Control Point, loaded with ISCP software Version 4.4 (or higher), available from Telecordia, Murray Hill, N.J. In an alternative embodiment of the invention, the SCP 68 may be a Lucent Advantage SCP, with software release 94, available from Lucent Technologies, Inc. In the present invention an IVR is provided by the TUI Application Server. An exemplary IVR is available under the trademark CONVERSANT System for IVR, Version 6.0, Update 1, provided by Lucent Technologies, Inc. The network alternatively incorporates any compatible stand-alone IVR or advanced intelligence network-intelligent peripheral (AIN-IP or intelligent peripheral) providing an IVR.

The SSP 89 in the terminating central office (CO) (SSP) for the subscriber phone 61 and the SSP 69 is the originating CO(SSP) for the calling party 60. However, the terminating CO(SSP) and the originating CO(SSP) may be the same SSP.

A data network of the invention includes a Web Client 70, and a Web server 55, and Master Directory Server (MDS) 54 accessible through the Internet 57. The MDS is an LDAP server in the present example of the invention. The Web Client 70 includes a personal computer (PC), i.e., a graphical user interface (GUI) 59, operating client software 58, an example of which is ICW Client, available from Southwestern Bell Telephone Company. Alternatively, the client software 58 can be run at the Web server 55. The TUI Application Server 80 provides the subscriber interface to the subscriber phone 61 (or other DTMF telephone) and the Web Client 70 (or other Internet compatible GUI) through the Web server 55, via the Internet 57. The MDS also maintains FMFM settings for the TUI Application Server.

The Web Client 70 incorporates a Web browser, such as Microsoft Internet Explorer, available from Microsoft Corporation, or Netscape Navigator, available from Netscape Communications Corporation. In one embodiment, the Web Client 70 is implemented with an IBM Pentium based PC, running the Linux operating system, available from, for example, Free Software Foundation, Inc., or the Microsoft Windows operating system, and running the Microsoft Internet Explorer, Netscape Navigator (available from Netscape/AOL) or HotJava (available from Sun Microsystems, Inc.) Web browser software. An exemplary embodiment of the invention includes the Web server 54 running the Linux or Microsoft Windows operating system and the Apache Web server software, available from the Apache Software Foundation, or the Jigsaw Web server software, available from World Wide Web Consortium (W3C).

A subscriber can modify the FMFM settings via two methods. First, from any DTMF telephone, the subscriber dials a UC platform access for their area number, to access the TUI Application Server 80. The subscriber is prompted to enter an account number, along with a personal identification number (PIN), further discussed below. The subscriber then has the ability to change the PIN, change the FMFM contact numbers, or toggle the FMFM service on and off. Second, the subscriber has the option to access the FMFM settings using a GUI via the Internet 57. Over the Web connection, the subscriber is able to implement all of the IVR functions identified above, as well as build the priority screening list and design the weekly scheduler.

The key contacts list (KCL) is available for use at the subscriber's option. The KCL contains the names and telephone numbers of KCL callers, as designated by the subscriber. In an example of the present invention, if the KCL has been activated, the FMFM will only activate for calls originating from phone numbers included in the KCL. All other calls are terminated at the subscriber's phone 61 voicemail. The KCL is implemented through a screening table, which is stored in the MDS 54 and is accessible by the subscriber via the Internet 57 as discussed below.

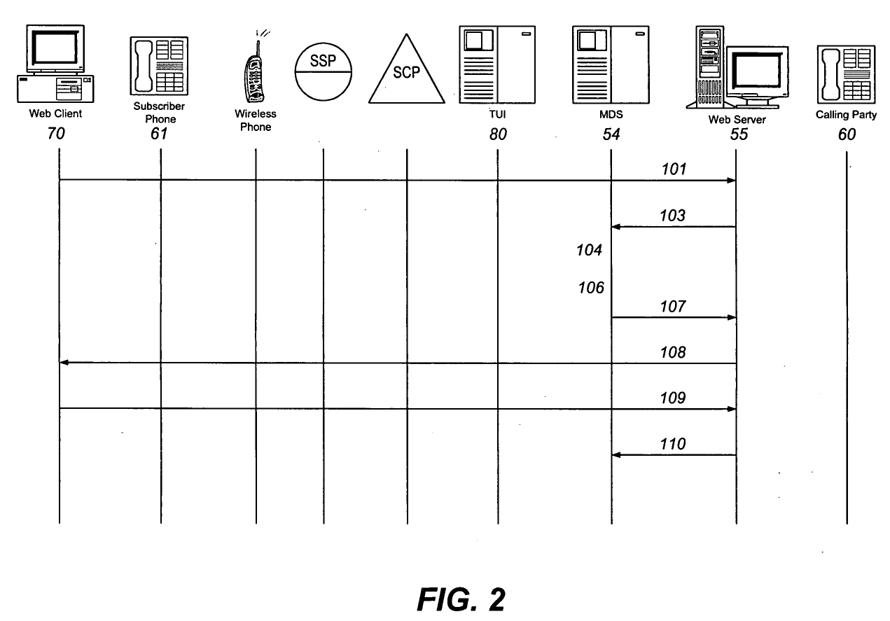

A subscriber's exemplary interaction with FMFM settings stored in the MDS is depicted in the call flow diagram of FIG. 2. The subscriber is able to access the FMFM settings via a telephone over the TUI Application Server or the Internet, thereby greatly increasing flexibility and convenience. FIG. 2 depicts interaction with FMFM over the Internet, using a GUI, for accessing and updating the more complicated procedures for customizing the service, including building the priority screening lists and weekly schedules, discussed above. In order for the subscriber to access FMFM via the Internet 57, the subscriber accesses a unique uniform resource locator (URL) associated with the service provider. The URL is an address and identifies the appropriate protocol for communicating with the service over the Web. The Master Directory Server (MDS) contains subscriber profiles and settings information that the Web Sever uses to render web screens to the subscriber. When the subscriber accesses the Internet, the Web server 55 provides FMFM Web screens rendered from the MDS subscriber profiles and settings information.

As shown in FIG. 2, at step 101 the subscriber accesses FMFM settings by connecting from the Web Client 70 to the Web server 55 through the Internet 57. The Web server 55 then accesses the MDS 54, which stores and updates the FMFM settings in the MDS, at step 103. The Web Server 55 receives HTTP messages from the subscriber Web Client 70 and provides HTML Web pages in response to the subscriber's input. The Web pages relate to the subscriber's FMFM settings, as stored in the MDS 54.

Once connected to the Web server, the Web Server uses the information stored in the MDS to decide what to show the end-user. The user provides authentication information to access the corresponding account. The Web Server performs the authentication at step 104. The Web Server queries the subscriber for an account name and associated password, which confirms the user's identity. The Web Server then retrieves the account name or an account identifier and associated password information the MDS to confirm that the subscriber is an authorized user. After successful authentication, the Web Server retrieves the FMFM settings from the MDS at step 106. The Web server 55 retrieves the FMFM settings from the MDS 54 at step 107. The Web Server then forwards the FMFM settings to Web client 70 via the Internet 57 at step 108 render web screens at the Web client. The FMFM settings input by the subscriber in are entered and are sent from the Web client 70 to the Web server 55 at step 109. The subscriber input is stored in the MDS 54, indicated respectively at steps 109 and 110 of FIG. 2.

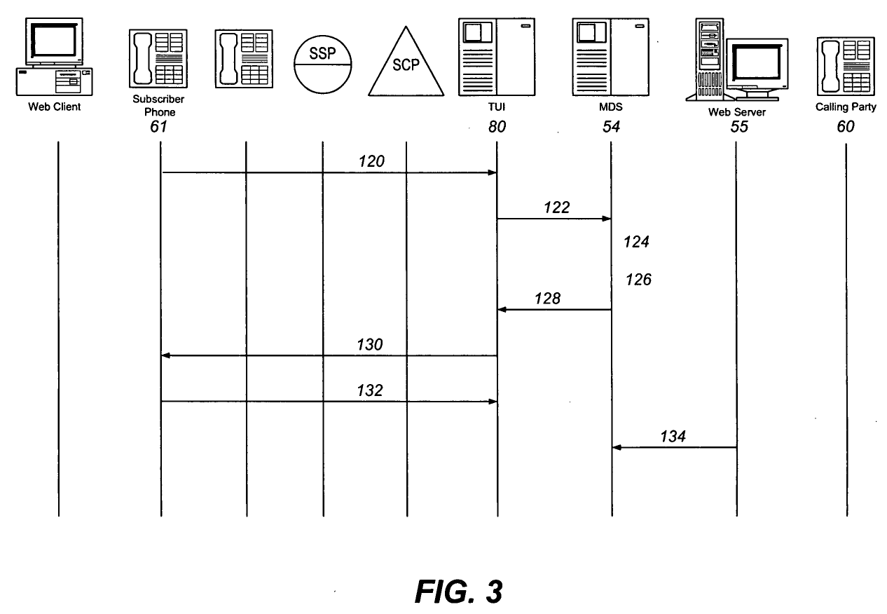

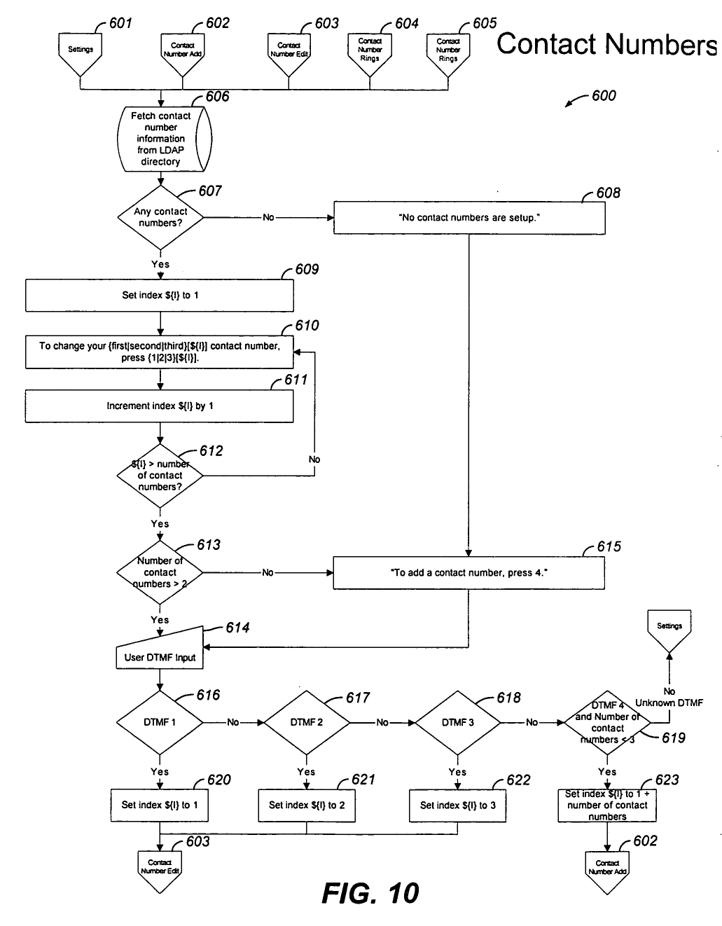

Exemplary steps through which the subscriber can alternatively interact with FMFM settings using the TUI 80 are now described. The subscriber can access all of the FMFM settings, including but not limited to toggling the FMFM service ON or OFF, contact numbers, KCL, sub mailboxes, number of rings, sub mailboxes creation, and greetings. FIG. 3 depicts interaction with FMFM settings over the TUI 80, using a DTMF telephone 61. Turning now to FIG. 3, the subscriber calls the UC access number for their area from any DTMF telephone 61, which directly accesses the TUI Application Server 80, shown at step 120. FIG. 10 depicts, for example, the call originating from the subscriber phone 61. The TUI Application Server 80 receives the call and initiates a request for authentication information, including the account and PIN numbers. These numbers coincide with the account and PIN numbers used to access the FMFM service via the Internet 57. The pre-programmed voice announcements are stored in the TUI Application Server 80 and implemented in the TUI Application Server 80. The authentication information is provided using the touch tones of the DTMF telephone 61. The TUI Application Server 80 compares the authentication information in the MDS at step 122 for verification at step 124.

After verification, the system operates in much the same way as described above with respect to a GUI and the Internet. The TUI Application Server 80 retrieves at step 126 the current FMFM settings which includes the call forwarding data specific to the subscriber at step 128. The TUI Application Server 80 then verbally recites a menu of options to the subscriber at step 130 based on the information received from the MDS 54. For example, if the subscriber has previously built a priority screening list, activation of this list will be included among the options provided to the user over the telephone. The subscriber listens to the options and inputs various choices at step 132 via the telephone touch tone key pad, including, for example turning on FMFM or assigning greetings and contact numbers to sub mailboxes associated with a subscriber telephone number. The subscriber FMFM parameter information is then sent to MDS 54 for storage and later use by FMFM.

Returning now to FIG. 1, FIG. 1 indicates the web client 70 being directly connected to the Internet, for example, through a digital subscriber line (DSL) or integrated services digital network (ISDN) digital connection. However, any conventional Internet access may be used, including an analog dial-up connection, through a modem (not pictured) on the subscriber's telephone line and an ISP.

Voice data for the telephone call is transmitted from PSTN 66 or a voice over Internet protocol (VoIP) network including PSTN 66 and VoIP Gateway (GW) 52 and Gatekeeper (GK) 51. The gatekeeper determines where calls coming from the VoIP GW 52 should be routed. Normally calls are routed to TUI Application Servers implemented on a Sun/Solaris or PC/Linux platform. The VoIP GW provides a bridge between the PSTN and the Internet enabling PSTN telephone calls to be converted into VoIP calls.

A calling party telephone 60 is connected to a local SSP 69 whenever the caller telephone 60 goes “off-hook,” (i.e., the handset is removed from the cradle or is otherwise activated to receive a dial tone). The SSP launches an OHD trigger each time the calling party goes off-hook and dials a series of digits adhering to the switch's dial plan is dialed. The OHD trigger activated by the SSP 69 (SSP 1703 in the example of FIG. 18) causes call information to be sent to the SSP 89 (SSP 1704 in the example of FIG. 18) for processing, via the existing signaling system 7 (SS7) network. SS7 signal standards are well known in the industry. The SS7 call information includes the called party number and the calling party number.

The subscriber may selectively activate and deactivate the service as desired, using the web client 70 via the Internet 57, as discussed below, or using conventional dual tone multi-frequency (DTMF) telephone via the TUI Application Server. Announcements to a subscriber interacting with the system are made using the TUI Application Server. Alternative embodiments of the invention combine the various server and database functions described above into any practical combination of PSTN and data network systems. According to the invention, the subscriber is able to access his or her incoming and outgoing call log through a data network, independently of PSTN involvement.

Referring now to FIG. 1, a subscriber enters a list of contact numbers via the TUI Application Server or Web Server which are stored in the Master Directory Server (MDS) on the UC platform. The subscriber telephone is forwarded to the UC platform when the telephone is not answered. In the present example of the invention, call forwarding is performed by the subscriber's local serving office (a central office (CO) switch or SSP). In the present example, call forwarding is activated through UC service order process. The TUI Application Server processes the call at the UC platform. Once the caller has listened to a prompt offering to find the subscriber and the caller has elected to find the subscriber, FMFM begins calling the FMFM contact numbers according to the FMFM settings stored in the MDS. Using the first contact number supplied by the subscriber in their configuration of the FMFM as an index, the TUI Application Server 80 looks up the Gateway group that matches the local calling scope or Local Access Transport Area (LATA) of the FMFM contact number. The TUI Application Server 80 requests an out dial port (phone line) and Gateway for the given Gateway group from the Gatekeeper.

The Gatekeeper responds with a specific Gateway and port to use for the out dial. The TUI Application Server 80 connects a VoIP session in the Gateway and requests that the Gateway dial the first FMFM contact number. The Gateway dials the first FMFM contact number. Call status events including call answering are passed to the TUI Application Server 80 from the PSTN. When the call is answered, it is assumed they are the subscriber. FMFM provides call path duplication, which provides caller identification to the called party to eliminate the need to record and announce the calling party's name. Dynamic out dialing eliminates calling contact numbers unnecessarily, thereby speeding up the process of finding the subscriber. At the end of the call, the TUI Application Server 80 signals the Gateway to end the call to the contact number. After the call is finished, the FMFM VoIP session is disconnected. The caller is then disconnected.

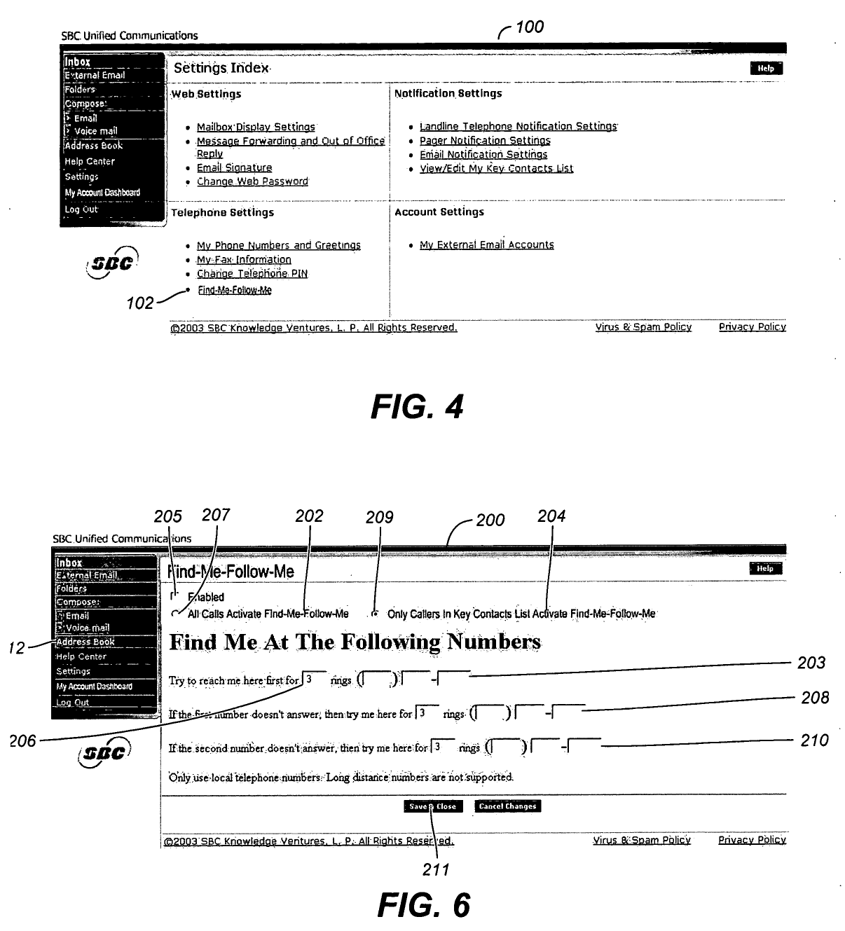

Turning now to FIG. 4, FIG. 4 illustrates an exemplary FMFM configuration access screen 100. A subscriber can enable and configure the FMFM service parameters via the web client 70 over the Internet 57 as shown in FIG. 1. FMFM can also be configured via the TUI Application Server 80. The Web Server presents FMFM configuration screens and configuration parameters such contact numbers, number of rings, sub mailboxes, etc. which are stored on the MDS 54. The Selection of Find-Me-Follow-Me 102 enables a subscriber to access the FMFM screen 200 for configuration of the FMFM settings including all information related or used by FMFM shown in FIG. 6. Subscriber mailboxes that are not part of a Group Mailbox and sub-mailboxes that are part of a Group Mailbox have access to the FMFM configuration screen 200. The checkbox 205 to the left of the “Enabled” label will enable the FMFM service when checked. When the checkbox is not checked, FMFM is disabled for this mailbox.

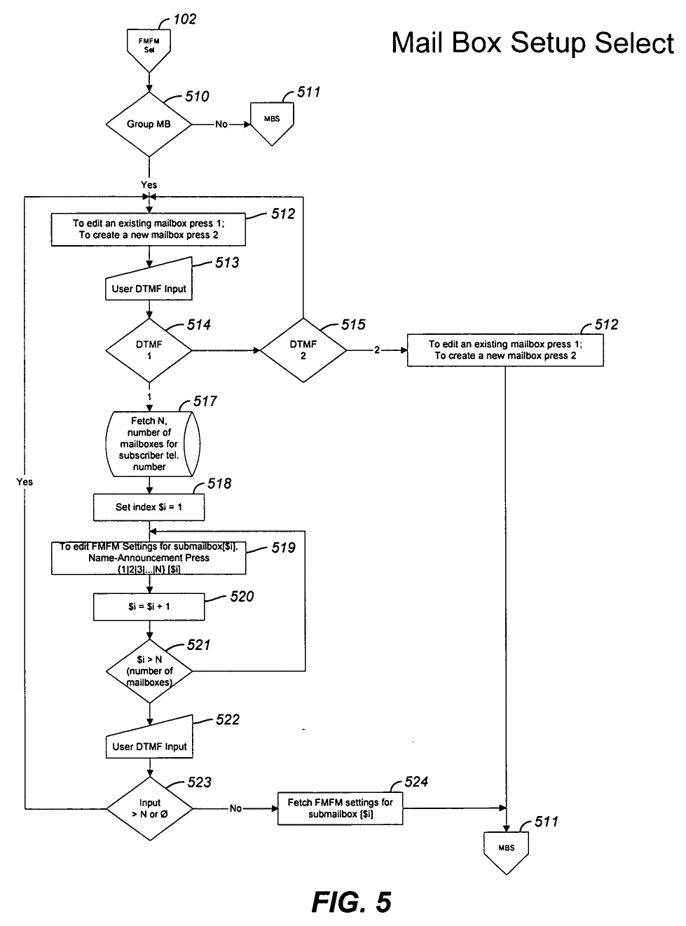

Turning now to FIG. 5, FMFM sub mailbox setup and creation is illustrated. Prior to entering parameters and accessing FMFM setting screen 200 shown in FIG. 6, TUI Application Server determines if the subscriber that is currently logged onto the system has a group mailbox 0.510 as shown in FIG. 5. If the subscriber has a group mailbox, FMFM prompts the user to enter a 1 to edit an existing mailbox, which is one of the mailboxes associated with the subscriber. The subscriber has a group mailbox if more than one mailbox is assigned to the subscriber. Each mailbox assigned to a plurality of users at a single telephone number is referred to as a sub mailbox. TUI Application Server prompts the user to enter a 2 to create a new mailbox. This new mailbox would be an additional mailbox to the mailbox or mailboxes already assigned to the subscriber. Upon user input 514 of 1 TUI Application Server proceeds to 517 fetch N, the number of mailboxes assigned to the subscriber. TUI application server then prompts the user for each sub mailbox 1-N as follows. FMFM sets the index $i to 1 518 and proceeds to prompt the user 519 “To Edit FMFM Settings for” sub mailbox [$i].name (the sub mailbox owner's name) “Press {1|2|3| . . . |N}[$i].” TUI Application Server then increments the index 520 and if the index $i is less than N 521 TUI Application Server then prompts the user for the next sub mailbox owner name or number. TUI Application Server then accepts user input 523. If user input is greater than N or is 0, then the user has requested a mailbox number that is out of range and FMFM repeats the prompt at 512. If the input is greater than 0 and less than or equal to N, the FMFM accepts the mailbox selection and proceeds to MBS 511 where FMFM setting are entered for the selected sub mailbox.

If the user/subscribers chooses to create a new mailbox by entering a 2 515, the FMFM assigns an additional new mailbox to the subscriber places default FMFM settings associated with the mailbox in the MDS. Default settings comprise FMFM enabled and All Calls Enabled for FMFM. TUI Application Server then prompts 511 the subscriber or user to enter FMFM settings for the new mailbox.

The subscriber can either elect to have all calls activate the FMFM service or can limit FMFM to be activated only for callers who are in the Key Contacts List (KCL) 204. Selection of All callers or KCL is accomplished by clicking on one of the two radio buttons 207, 209 labeled “All Calls Activate FMFM” 202 or “Only Callers In Key Contacts List Activate FMFM” 204. The number of rings 206 and contact telephone numbers 203, 208 and 210 are entered via FMFM screen 200. In the present example, long distance numbers are not supported, however, the option of supporting long distance contact numbers can be provided.

Subscriber information such including FMFM settings, FMFM configuration, FMFM contact numbers, FMFM contact number of rings, Key Contacts List, Address book, server class, password, preferences, contact phone numbers, number of rings etc. are stored in the Master Directory Server (MDS) as shown in FIG. 1. In the present example of the invention, the MDS is resident on the UC or can be connected to the UC.

When only callers in the KCL activate the FMFM service by calling a subscriber, the caller's telephone number is compared to each of the phone numbers in a subscriber's MDS address book of entries or a KCL created by the sub mailbox owner. All telephone numbers listed in the KCL or MDS Address Book will be used as key contact numbers to determine if an inbound caller's telephone number matches entries in the KCL. Turning now to FIG. 6, the user using the GUI can add and delete numbers in the MDS Address Book or KCL with a screen similar to the FMFM screen 200 in which FMFM contact phone numbers are entered. Access to the address book screen is provided from screen 200 by selecting the menu item Address Book 212.

In the present example of the invention, the end-user can set up to three contact numbers 203, 208 and 210. Additional numbers can be added if desired. The contact numbers are displayed and input in the same order or sequence that the FMFM feature of the system will try calling the contact numbers. Additionally, the end-user can set the number of rings 206 for each FMFM contact number that is tried before moving on to the next number or directing the incoming call to voicemail.

A similar GUI screen or TUI menu of announcements is provided to assign sub mailboxes, FMFM contact numbers and sub mailbox greetings associated with a group mailbox assigned to an FMFM subscriber telephone number. These sub mailbox assignments, sub mailbox greetings and FMFM contact numbers are stored in the MDS.

The FMFM contact telephone number input by the subscriber should result in a fully formed 10-digit telephone number. If the telephone number is malformed, an appropriate error message will be displayed for the end-user (not shown). In the present example of the invention, the number of rings can be set between 2 and 20. The default value is 3. An edit check is performed when the end-user clicks on the “Save & Close” function to enforce the ring range. If the number of rings is outside the ring range, an appropriate error message is displayed for the end-user (not shown).

In the present example of the invention, a subscriber can only set contact numbers that are in the same Local Access Transport Area (LATA) as their landline Working Telephone Number (WTN) that the FMFM service is associated with. An edit check is performed when the end-user clicks on the “Save & Close” 211 to enforce the Intra-LATA rule. If calling the contact number from the WTN would result in an Inter-LATA call, an appropriate error message is displayed for the end-user (not shown). In an alternative embodiment of the invention, the intra-LATA restriction is not enforced.

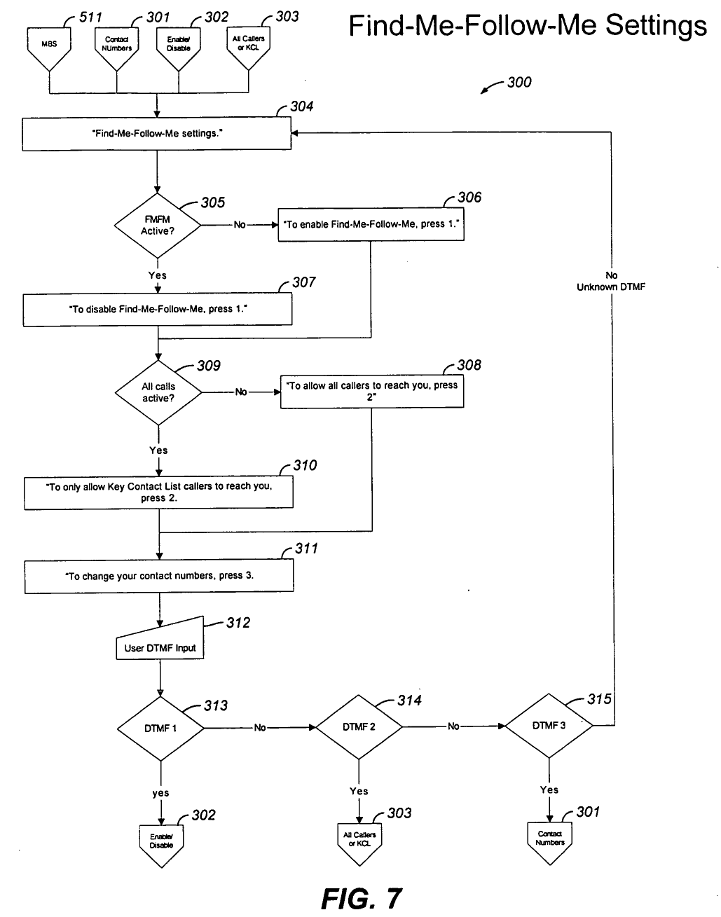

A subscriber can access FMFM settings via the TUI/IVR using a telephone DTMF input as shown in FIG. 7. A subscriber can also access FMFM settings via the GUI using screens stored in the MDS and generated by a GUI menu function. FIG. 7 illustrates the main settings for the FMFM functionality via a telephone DTMF input. A subscriber calls in from the PSTN to the FMFM settings function (FMFM) to configure the FMFM service via the TUI. Changing the FMFM settings can alternatively require authentication by entry of password stored in MDS for comparison and validation. Once the subscriber is authenticated and connects to FMFM configuration menus, the TUI Application Server announces “Find-Me-Follow-Me settings” 304. An end-user can: enable/disable FMFM 302 (option 1), activate FMFM on all calls or activate FMFM only for callers in the Key Contacts List (KCL) 303 (option 2), or access a menu to change, delete, or add contact numbers 301 (option 3). Both options 1 and 2 are toggles. If FMFM is on 305, FMFM announces “To enable Find-Me-Follow-Me, press 1. If FMFM is off 305, FMFM announces “To disenable Find-Me-Follow-Me, press 1.” If “All calls Active” is off 309, FMFM announces “To enable all callers to reach you, press 2.” If All Calls Active is on 309, FMFM announces “To only allow Key Contact List Caller to reach you, press 2.” FMFM then announces “To change your contact numbers, press 3” 311. FMFM then accepts DTMF input 312 from the subscriber telephone. If the subscriber inputs DTMF 1 313 FMFM proceeds to 302 Enable/Disable FMFM. If the subscriber inputs DTMF 2 314 FMFM proceeds to 303 All Callers or KCL. If the subscriber inputs DTMF 3 315 FMFM proceeds to 301 Contact Numbers.

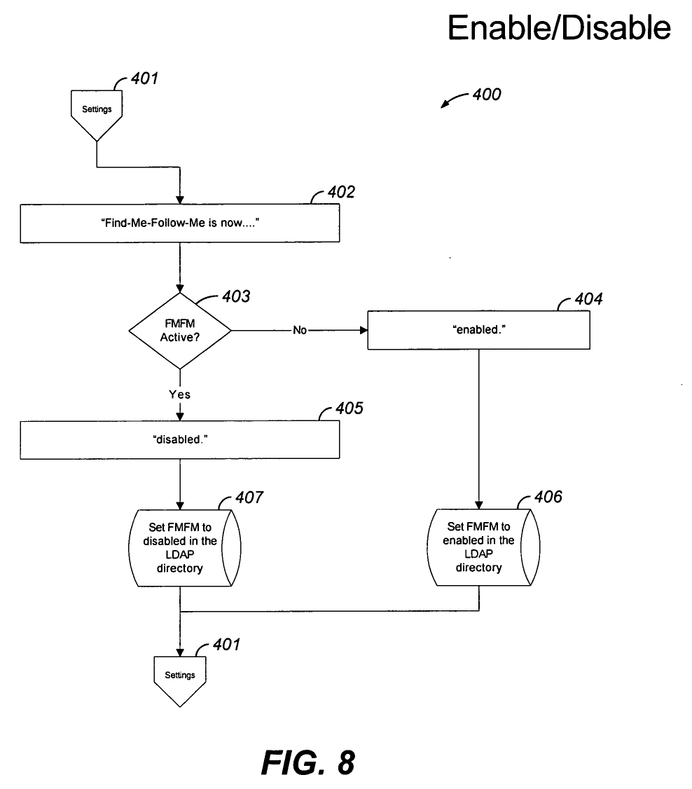

FIG. 8 illustrates the user input for enabling/disabling FMFM 302. Both option 1 and option 2 are toggled, that is, when the option is on, selecting the option turns it off. When an option is off, selecting it turns it on. FIG. 8 illustrates the user feed back for enabling/disabling FMFM, option 1 in FIG. 4. FMFM announces 402 “Find-Me-Follow-Me is now.” and if FMFM is active 403 FMFM announces “disabled” and proceeds to 407 set FMFM to disable in the MDS. If FMFM is not active, FMFM announces “enabled” 404 and proceeds to 406 set FMFM to enabled in the MDS.

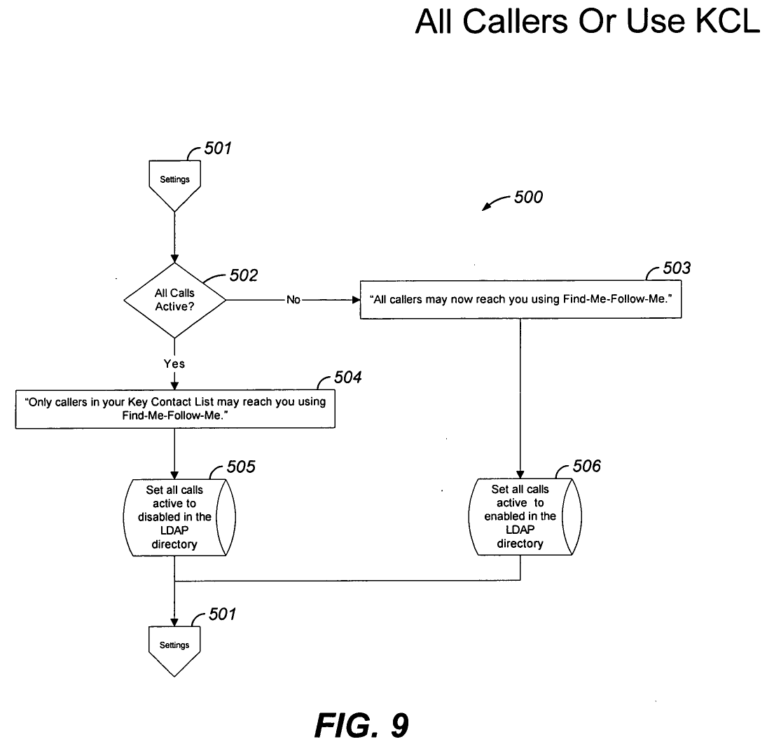

FIG. 9 illustrates the end-user feedback when the subscriber/end user has selected option 2 303 to activate FMFM on all calls or just for callers in the Key Contacts List (KCL). If all calls active is off 502 FMFM toggles the setting and announces “All callers may now reach you using Find-Me-Follow-Me” 503 and proceeds to set all calls active to enabled in the MDS. If all calls active is off 502 FMFM toggles the setting and announces “Only callers in your Key Contact List may now reach you using Find-Me-Follow-Me” 504 and proceeds to set all calls active to “disabled” in the FMFM settings in the MDS.

FIG. 10 illustrates an example of how end-users access the FMFM settings to add or change contact numbers. As shown in FIG. 10, FMFM function enters the contact numbers functionality for settings 601, Contact Number Add 602, Contact Number Edit 603, Contact Number Rings 604. FMFM Fetches Contact number information from the MDS 606. If there are no contact numbers 607 FMFM announces “No contact numbers are set up” 608. If no contact numbers are set up, FMFM announces “No contact numbers are set up” 608 and “To add a contact number, press 4” 615 and proceeds to accept DTMF input from the subscriber 614. If contact numbers are set up, FMFM sets index $ {i} to 1 609 and announces “To change your {first|second|third}[${i}] contact number, please press {1|2|3}[${i}]” 610 and increments index to ${i} by 1 611. If the index is greater than the number of contact numbers 612 FMFM proceeds to 613 to check if the number of contact numbers is greater than 2. If the index is not greater than the number of contact numbers, FMFM returns to announce the next contact number 610. If the number of contact numbers is greater than the maximum, in the present example the maximum is 2, then FMFM proceeds to accept DTMF input from the subscriber 614.

If the subscriber DMTF input is 1 616, FMFM sets the index ${i} to 1 620, and proceeds to edit the contact number 1. If the subscriber DMTF input is 2 617, FMFM sets the index ${i} to 2 and proceeds to edit the contact number 2 621. If the subscriber DTMF input is 3 618, FMFM sets the index ${i} to 3, and proceeds to edit the contact number 3 622. If the subscriber DTMF input is 4 and the number of contact numbers is less than 3 619, FMFM sets the index ${i} to 1 plus the number of contact numbers, and proceeds to add a contact number 602. Note that the menu for announcements is dynamically created based on the current contact number settings for the mailbox.

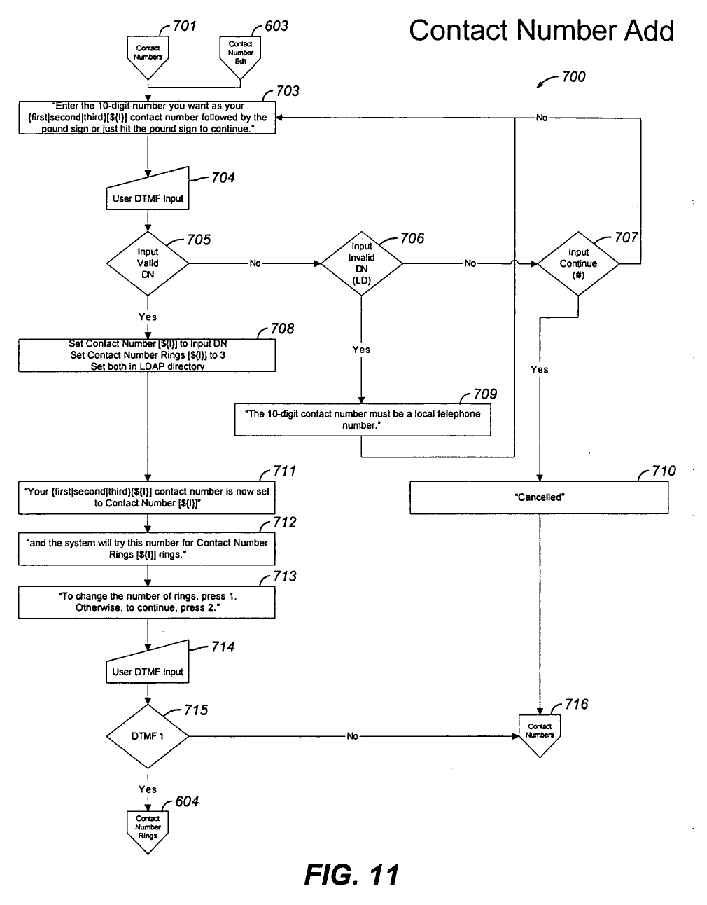

FIG. 11 illustrates how the end-user adds contact numbers. Once a contact number is added, the end-user can change the number of rings from the default value of 3 to another value. As shown in FIG. 11, FMFM announces “Enter the 10 digit number you want as your {first 1 second 1 third}[${i}] contact number followed by the pound sign or just hit the pound sign to continue” at 703. FMFM then accepts subscriber DTMF input at 704. If the input DN is a valid local telephone number (DN) then FMFM proceeds to set the contact number [$ {i}] to the input DN, sets contact number rings the input DN to 3 and places both settings in the MDS at 708. FMFM then announces “Your {first 1 second 1 third} [$ {i}] contact number is now set to contact number [${i}] ” at 711 and “the system will try this number for contact number rings [${i}]: at 712. FMFM then announces “To change the number of rings, press 1, otherwise, to continue press 2” at 713. FMFM then accepts subscriber DTMF input at 714. If the subscriber DTMF input is 1, then FMFM proceeds to Contact Number Rings at 604. If the subscriber DTMF input is not 1, then FMFM proceeds to Contact Numbers at 716. In one example of the invention, if the input DN is a long distance number at 706 FMFM announces “The 10-digit contact number must be a local telephone number” 709. If the subscriber input is a pound sign (”#”) then FMFM announces “cancelled” at 710 and proceeds at 716.

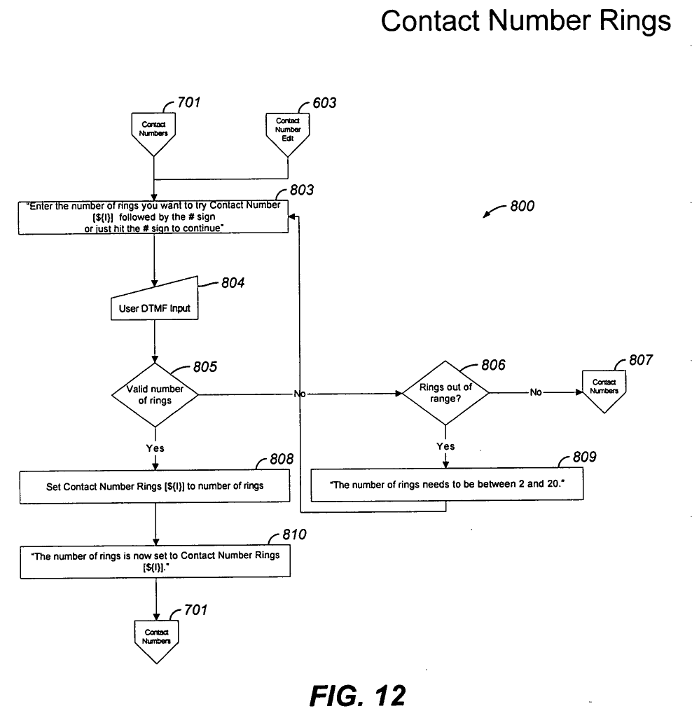

FIG. 12 illustrates how the end-user sets the number of rings on a contact number. The number of rings in the present example is a number between 2 and 20 rings. FMFM prompts the subscriber at 803 for the number of rings and accepts input 804. If the number of rings is valid at 805 FMFM sets the input to the number of rings in the MDS and announces the setting to the subscriber 810. If the number of rings is out of range FMFM announces “the number or rings needs to be between 2 and 20.” at 809

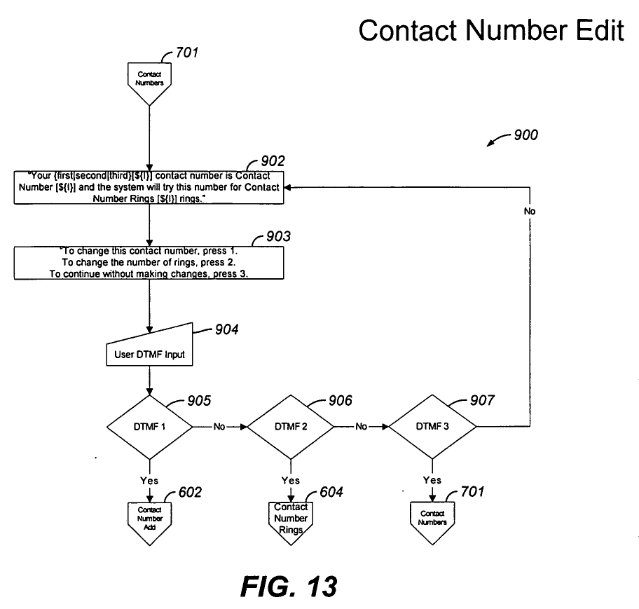

FIG. 13 illustrates the menu for changing the contact number or the number of rings for an existing contact number. This contact number can also be deleted. FMFM prompts the user by announcing a selected contact number and the number of rings 902. FMFM then requests subscriber input 903 1 to change contact number, 2 to change the number of rings and 3 to continue making changes. FMFM accepts subscriber input 904 and if DTMF is 1 905, proceeds to change contact number 602, if DTMF is 2 906, proceeds to change the number of rings 604 and if DTMF is 3, proceeds to continue making changes to contact number 801. If DTMF is not 1, 2 or 3, FMFM proceeds to the selected contact number 902.

The following FMFM call flows describe the user experience when the FMFM service is active on a mailbox. The call flows illustrate how Group Mailboxes and sub mailboxes are handled. At a high level, FMFM is activated after the system has determined specifically for which mailbox a given inbound call is destined. When dealing with Group Mailboxes, that is when a plurality of sub mailboxes are defined for a single telephone number, the individual sub mailbox is determined before FMFM is activated.

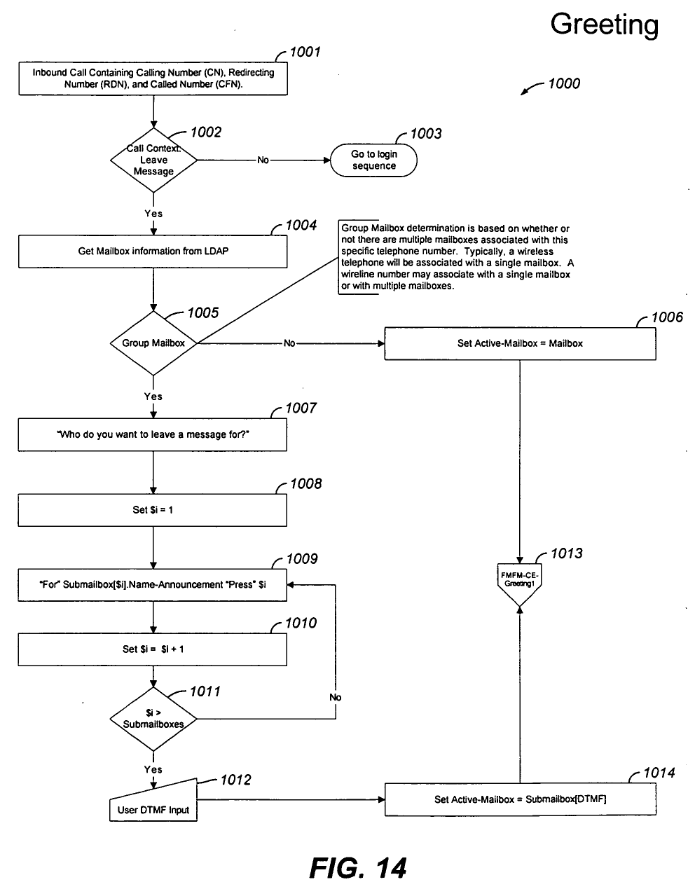

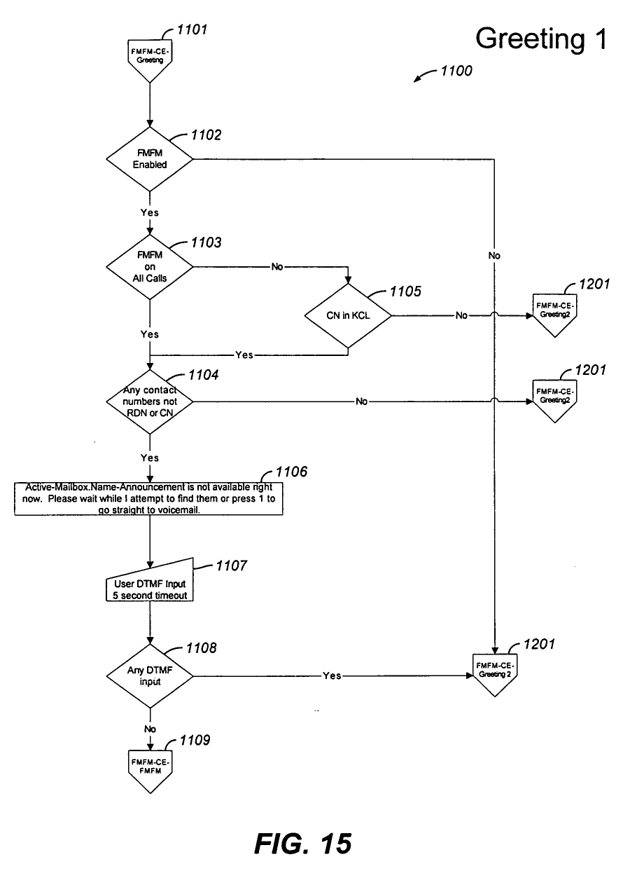

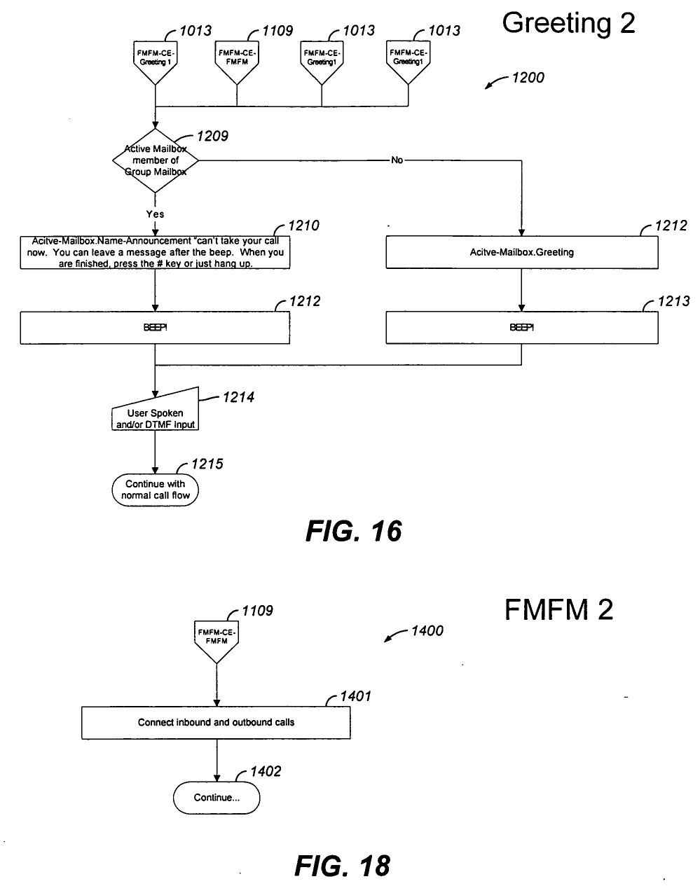

FIG. 14 call flow illustrates how greetings are used to determine the sub mailbox with which the inbound call will be associated. FIG. 14, FIG. 15 and FIG. 16 are closely related. In FIG. 14 (“Greeting”) the greeting type (single mailbox or Group Mailbox) is determined and the correct greeting is played. If the mailbox is a Group Mailbox, the sub mailbox selected by the caller is set to the active mailbox.

As shown in FIG. 14, in inbound call containing a calling number (CN), Redirecting Number (RDN), and Called Number (CFN) is received 1001. If the called number is the subscriber's telephone number the call context is to leave a message and FMFM gets the subscriber's group mailbox information from the MDS associated with the subscriber's telephone number.

MDS FMFM settings includes but is not limited to group mail information, sub mail boxes associated with a group mail box, greetings for group mailboxes and sub mailboxes, FMFM contact numbers and number of rings for each contact number. At block 1005 FMFM determines if there is a group mailbox associated with the subscriber telephone number by fetching the number of mailboxes, N associated with the subscriber telephone number or subscriber name from the MDS. If there is more than 1 mailbox associated with the subscriber then the mailbox is a group mailbox with sub mailboxes. The number of sub mailboxes associated with the telephone number is N. If there is a group mailbox associated with the subscriber's group mailbox, FMFM asks the caller “Who do you want to leave a message for” at 1007 and sets a sub-mail box index to 1. At 1008 FMFM then goes through each sub mail box 1009 owner name greeting and asks the caller to enter a number corresponding to the desired sub mailbox owner. 1010, 1011 FMFM uses the sub mailbox owner name associated with the sub mailbox index in the MDS. FMFM then accepts DTMF input from the caller to select a sub mail box at 1012. FMFM sets the active mailbox to the sub-mail box selected by the caller at 1014. If there are no sub mailboxes associated with the group mailbox, FMFM sets the active mailbox to the group mailbox associated with the subscriber at 1006. FMFM then proceeds to FMFM-CE-Greeting1 at 1013.

The active mailbox determined in the call flow above (“Greeting”) is used to determine the FMFM settings. If FMFM is active, and the inbound call matches the selection criteria (all callers or just callers in the Key Contacts List), the caller is routed to FMFM. Otherwise, the caller is routed to the mailbox greeting where the caller can leave a message for the end-user.

FIG. 15 illustrates the call flow once the active mailbox has been determined. Note that the present example of the invention enables subscribers to associate their wireless phone to a sub mailbox. It is reasonable for a call to the customer's wire line telephone number to attempt to locate the end-user at their wireless phone. Also, direct calls to the wireless phone are able to take advantage of the FMFM feature. If FMFM is not enabled in the MDS, FMFM proceeds to FMFM-CE-Greeting2 1201 shown in FIG. 16, and announces a greeting 1212, sounds a beep tone 1213 and takes caller spoken input or DTMF input 1214. If FMFM is enabled in the MDS FMFM determines if FMFM is enabled for all calls 1103 or key calls only 1103. If FMFM is enabled for key calls only, FMFM check to see if the caller number is in the subscriber's address book or KCL in the MDS 1105 and if not FMFM proceeds to FMFM-CE-Greeting2 1201. If FMFM is active on all calls or if active on key calls only, as indicated in the FMFM settings and the calling party number is in the address book or KCL, FMFM determines if any contact number is not the calling party number (CN) nor an RDN 1104. That is, if all contact numbers appear in the inbound call path as either a CN or as an RDN, then there is no contact number that is not in the inbound calling path, and FMFM proceeds to voicemail FMFM-CE-Greeting2 1201. If there is any contact number that does not appear in the inbound calling path as either a CN or an RDN, FMFM announces, using an MDS stored greeting for the active mailbox owner: “mailbox (owner name) is not available, please wait while I attempt to find them or press 1 to go to voicemail.” FMFM then waits 5 seconds for a caller DTMF input 1107. Any DTMF input causes FMFM to proceed to FMFM-CE-Greeting2 1201. FMFM proceeds to FMFM-CE-FMFM 1109, absent DTMF input within 5 seconds.

One of the checks before FMFM is activated is to look to see that the neither the calling party number nor the Redirecting Number (RDN) is the only contact number. RDNs are the telephone numbers from which calls were forwarded. Typically, this would include either the subscriber's home, wireless or both numbers. If the RDN or the calling party number is the only contact number, it doesn't make sense to attempt that number again since the calling party called from the calling party number or originally called the RDN and it was not answered. The check is performed for all RDNs and the calling party number (CN). In the case of some product functionality, when the wireless phone is dialed by the caller and when active, the functionality sends the call on to the subscriber's home telephone number. In this case, if the home telephone number isn't answered, the call would forward on to the FMFM service. At that point, the call has two RDNs. The first RDN is the wireless telephone. The second RDN is the home phone number. Again, it would not make sense to expect the subscriber to answer at either of these telephone numbers since they were already tried and not answered. Moreover, if a subscriber called the home phone from the cell phone, it would not make sense to try to reach the subscriber at the home phone (RDN) nor the cell phone (CN) as the home phone was not answered and the subscriber is calling from the cell phone (CN).

Also, a calling party should be able to opt out of FMFM and go straight to voicemail. The caller is given 5 seconds to opt out before FMFM starts the FMFM out dial process. FIG. 16 illustrates how the announcements are handled and where the caller is able to leave a message when FMFM is not active for this call or when the caller elects to go directly to voicemail. FMFM determines whether the active mailbox is a member or sub mail box of group mailbox 1209 and plays either the appropriate sub mailbox greeting 1210 or a standard mailbox greeting 1212 from the message store. Greetings are stored in the message store and are accessed by the TUI through the AU. FMFM sounds a beep 1211, 1213 and takes caller input as spoken or keyed in as a DTMF input 1214.

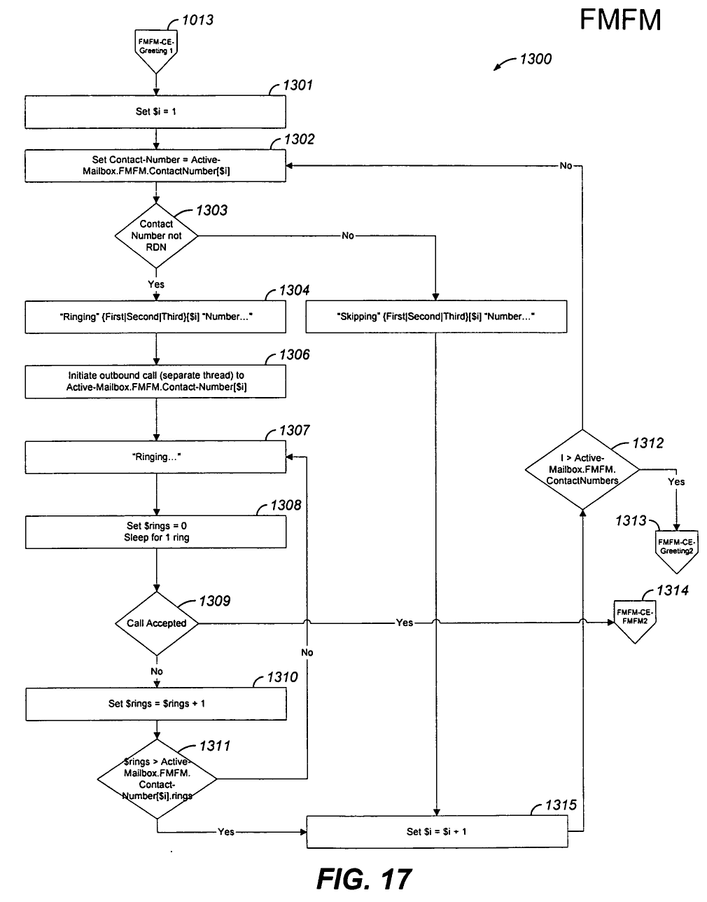

FIG. 17 illustrates the calling party experience while waiting for FMFM to locate their called party. As each FMFM contact number is tried, FMFM informs the calling party that it is trying a contact number. The system also tells the calling party that the system is still ringing the called party. This keeps the calling party in the information loop, providing proactive feedback so that the caller does not get bored and wander off or hang up. As shown in FIG. 17, FMFM sets index $i equal to 1 1301 and sets the contact number to =Active mailbox FMFM Contact number [$i] 1302 from the MDS contact numbers stored for the mailbox. If the current contact number at the current index $i is a RDN or the CN 1303, FMFM skips the current contact number 1305. This skipping avoids looping and delays associated with calling FMFM numbers that appear as an RDN or as a calling party number in an incoming call, as discussed above. FMFM then increments the index $i 1315 and if the index is less than or equal to the number of contact numbers in MDS FMFM settings, FMFM proceeds to the next contact number until all contact numbers have been tried or skipped.

If the contact number is not the calling party number or an RDN 1303 FMFM announces that it is ringing contact number associated with the index 1304 and initiates the outbound call to the contact number 1306. FMFM counts the rings 1308, 1310 and 1311 and once the number of rings exceeds the number of rings in the FMFM parameter number of rings for the current contact number 1311, FMFM increments the contact number index 1315 and proceeds to dial the next contact number 1302 or to FMFM-CE-Greeting2 1313.

When one of the contact numbers is also one of the RDNs or the CN appearing in the inbound calling path calling information, FMFM dynamic out dial skips this contact number and tries the next contact number in the contact number list or goes directly to voicemail if the contact number list is exhausted.

FIG. 18 illustrates that when the out dial call leg accepts the call, that the two calls, the inbound calling party call and the outbound contact number call are connected together 1401.

As a result of FMFM selection actions on the calling party side, discussed above, a separate call leg or thread is created to call the called party. This thread attempts to reach the called party at each of the FMFM contact numbers listed in the subscriber's contact number list from MDS (subject to skipping of RDN/CN considerations described above). When each out dial is initiated, the calling information supplied to the PSTN network SSP matches the Caller identification (original calling party number and name if available) information supplied on the inbound leg of the call. That is, calling party number and name information from the SSP on the out dialed call is made to match the Caller identification information from the SSP of the calling leg of the original call. Thus the original initiating caller identification information is inserted into each out dialed call as the calling party number in the SS7 link or VoIP gateway instructions. This allows the called party to effectively visually screen calls forwarded by using Caller identification. Additionally, the RDN in the outbound calling information is set to the last RDN for the inbound call.

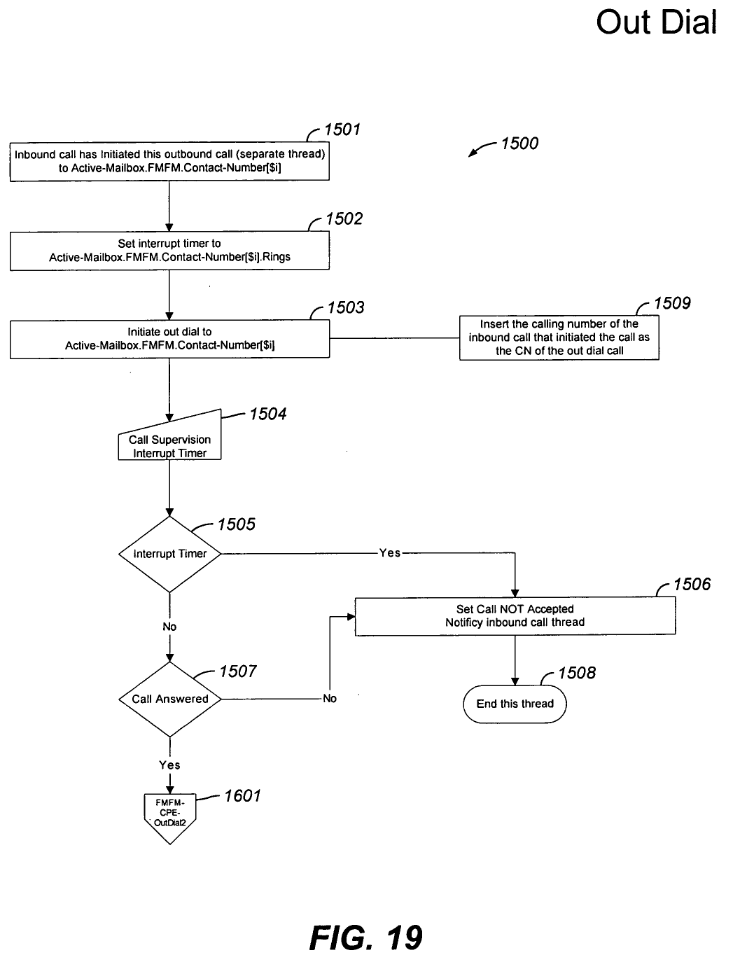

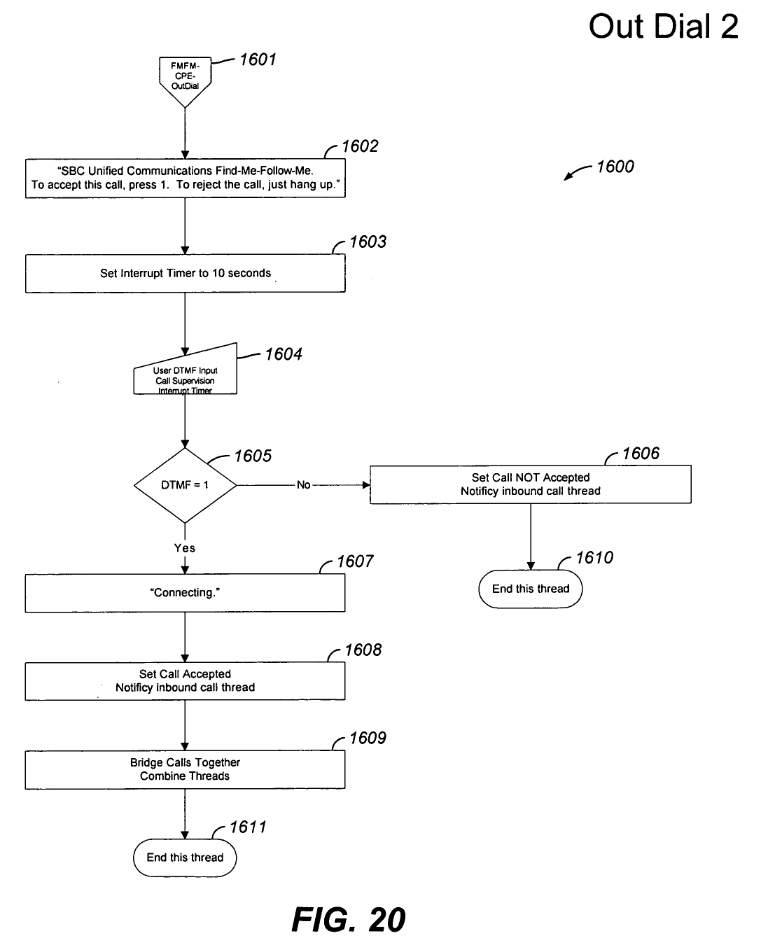

FIG. 19 and FIG. 20 are both integral to the called party experience. FIG. 19 and FIG. 20 are closely related. Note that the called party affirmatively accepts the call before the called party is connected. Affirmative acceptance prevents answering machines and voicemail systems from taking the call inappropriately. In an alternative embodiment, the calls are connected when the called party answers without waiting for affirmative acceptance.

Turning now to FIG. 19, an inbound call has initiated an outbound call to a currently indexed, i^{th} contact number, Active-Mailbox.FMFM.Contact Number [$i] 1501. FMFM then sets an interrupt timer to the maximum number of rings for the i^{th} contact number. To perform Call Path Duplication for the call, FMFM inserts the calling party number (CN) from the SS7 call information that initiated the call, as the calling party in the SS7 call information for the out dial call 1509. FMFM then initiates an out dial to the Active Mailbox FMFM Contact number [$i] 1503 and monitors the number of rings in Call Supervision Interrupt Timer 1504. Once the interrupt timer counts the maximum number of rings allowed for the i^{th} contact number without an answer, FMFM proceeds to sets a Call NOT accepted variable in the FMFM settings and notifies the inbound call thread 1506. If the call is not answered 1507 such as when the line is busy, exceeds maximum number of rings or the called party answers and does not press 1 to accept the call, FMFM sets a Call NOT accepted variable in FMFM and notifies the inbound call thread 1506.

Turning now to FIG. 20, when the call is answered, FMFM announces “Find-Me-Follow-Me. To accept this call, press 1, to reject, just hang up.” 1602 FMFM sets an interrupt timer to 10 seconds 1603 waiting for subscriber DTMF input 1604. If the subscriber does not input DTMF 1, FMFM sets FMFM parameter Call Not accepted in the TUI Application Server to notify the inbound call thread and proceeds to end the thread. 1610 If the subscriber inputs DTMF 1 to accept the call, FMFM announces “connecting” 1607 to the calling party and sets the call Accepted FMFM parameter in TUI application server and notifies the inbound call thread. 1608 At this point FMFM bridges the calls together 1609 and ends the thread 1611.

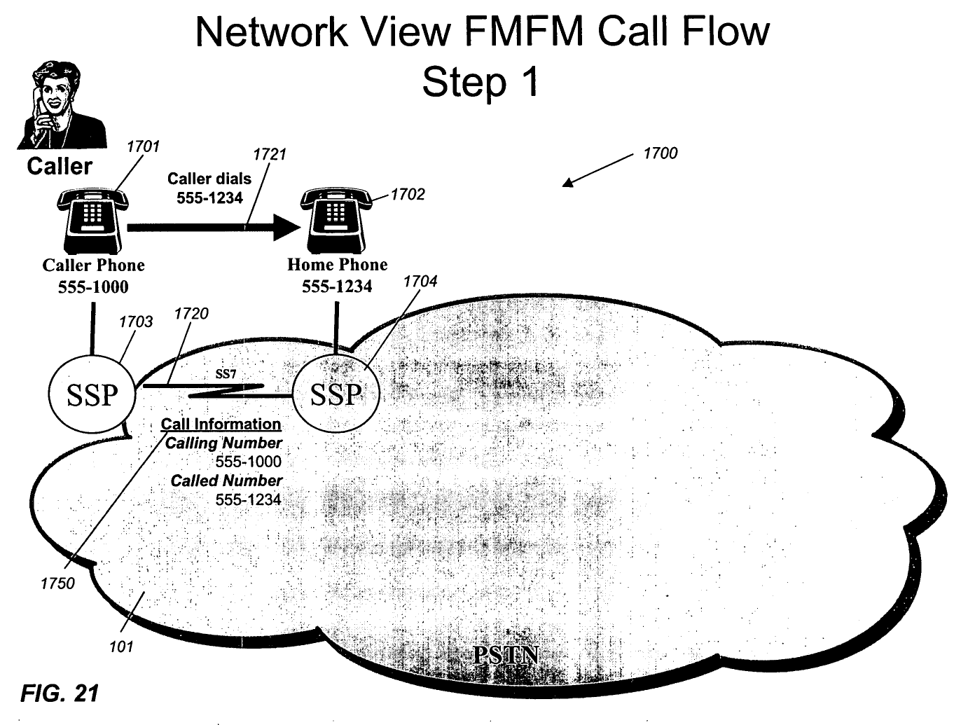

In order to clarify the use of call information, context, and sequencing, the following high level call flows are presented in FIG. 21-29. FIG. 21-29 illustrates an end-to-end view of the FMFM service from a high-level network perspective.

Turning now to FIG. 21, the first step is for a calling party telephone 1701 to call a called party telephone 1702 (a subscriber). The caller dials 555-1234 1721. In the present example, both the caller telephone 1701 and the called telephone 1702 are associated with the same PSTN 101. Separate PSTNs, however, could initiate and receive the call. The calling party dials 555-1234 on calling telephone 1701, causing the PSTN to send calling information 1750 from SSP 1703 to SSP 1704. SSP 1703 associated with the caller telephone in PSTN 101 sends the call information 1750 over SS7 link 1720. The calling information 1750 comprises the calling number (CN) (555-1000, the caller's telephone number) and called number (555-1234, the subscriber's telephone number) to a second SSP 1704 which is associated with subscriber home phone 1702.

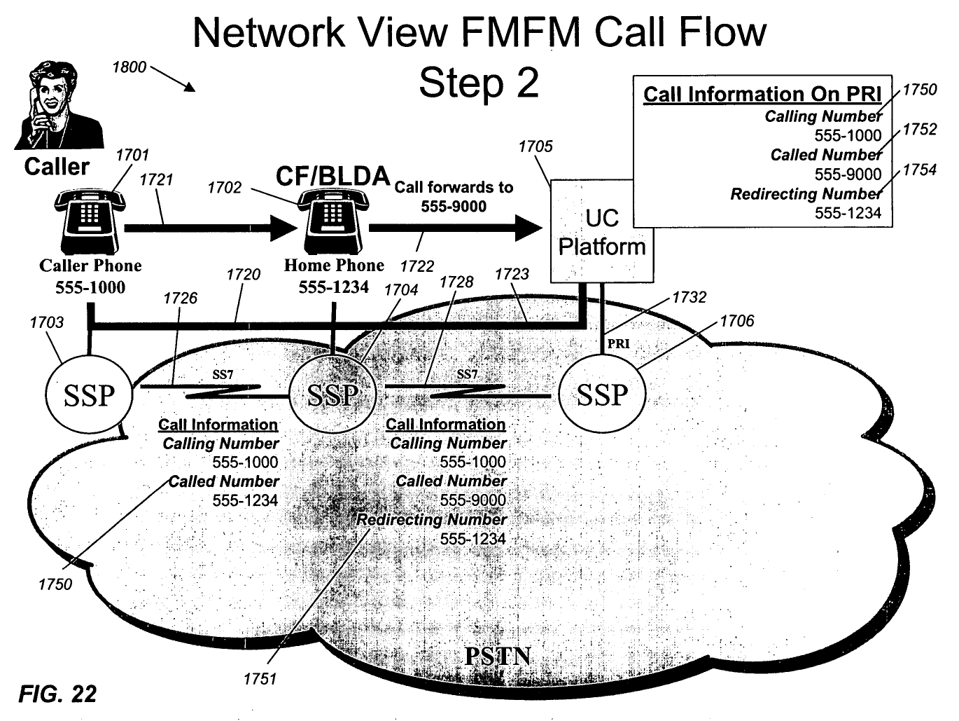

Turning now to FIG. 22, when the subscriber doesn't answer the phone 1702 or the line is busy, the call is set to be forwarded from SSP 1704 to SSP 1706 associated with the Call Forward Number (CFN) (555-9000) to the UC platform 1705 where FMFM resides. SSP 1704 passes call information 1751 to SSP 1706. Call information 1751 comprises calling number (CN) 555-1000, called number 555-9000 and redirecting number 555-1234. The CFN terminates on the UC platform 1705. SSP 1704 sends calling information over the SS7 link to SSP 1706, which connects to the UC platform 1705. The call information is sent to the platform through the digital PRI link 1732. The PRI link call information includes the caller's telephone number 1750 (shown as the Calling Number 555-1000 above), the called number 1752 (Called Number 555-9000 above) which is also the CFN-Call Forward Number (also referred to as “access number”), and the subscribers telephone number 1754 (Redirecting Number or RDN 555-1234 above). Primary Rate Interface (PRI) is an ISDN interface to primary rate access. Primary rate access consists of a single 64-kbps D channel plus 23 (T1) or 30 (E1) B channels for voice or data.

FMFM uses the inbound call's information to determine which mailbox or sub mailbox with which to associate the call and whether or not the call context is to leave a message. There are cases where a customer has per line blocking enabled. PRI lines are configurable to pass the RDN number even when the RDN line has per line blocking enabled. In this case, FMFM would look at a privacy indicator for the calling party number or RDN on inbound calls and not present private numbers as a calling party number to system users.

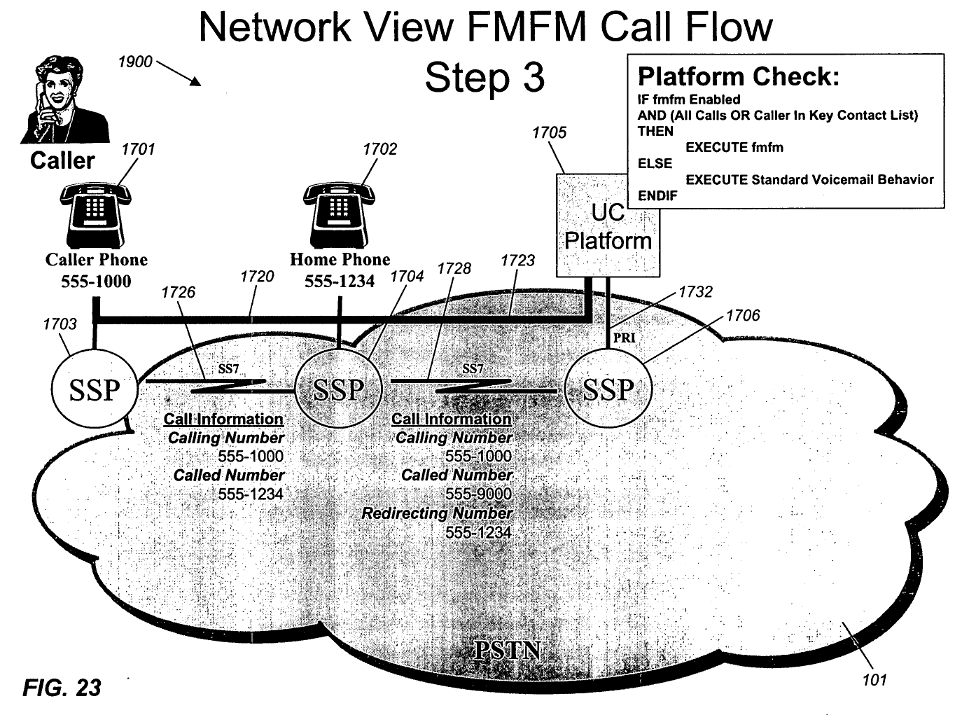

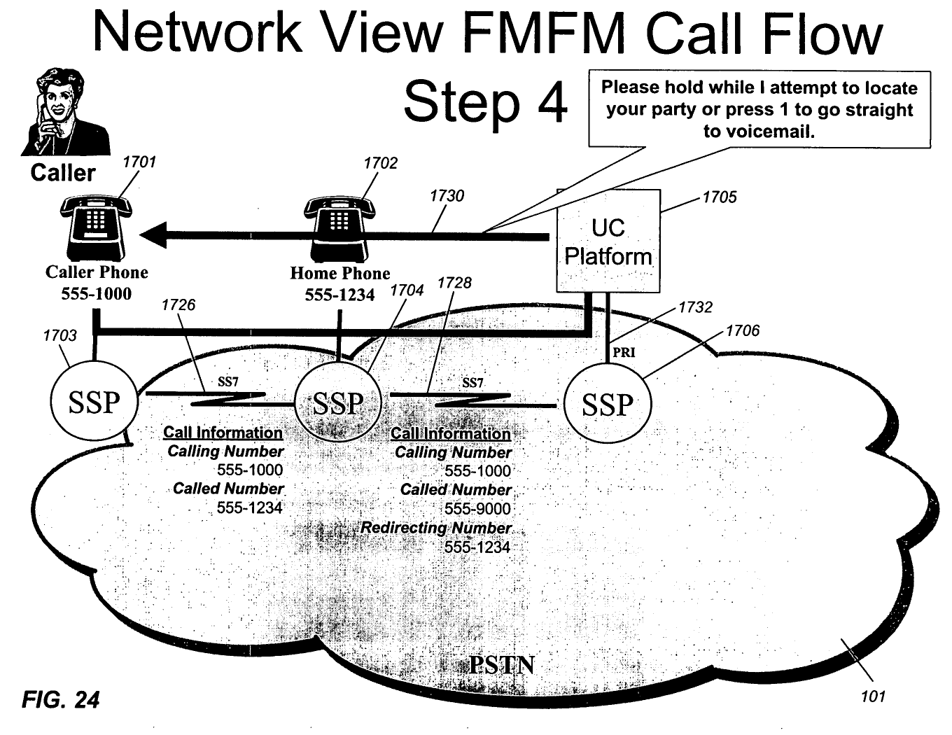

Turning now to FIG. 23, FMFM at the UC platform 1705 checks in the FMFM settings for the RDN telephone number to see if FMFM is active and applies to the incoming call. If FMFM does apply to the call, then the call goes on FMFM at the UC platform processing in FIG. 24. Otherwise, the calling party is sent to voicemail where the system plays a standard voice mail greeting and allows the calling party to leave a voice message. As shown in FIG. 24, FMFM asks the calling party to hold while FMFM attempts to locate the called party. FMFM also gives the calling party the option to go straight to voicemail. If the calling party elects to go straight to voicemail, the system plays the subscriber's greeting and gives them the opportunity to leave a voice message.

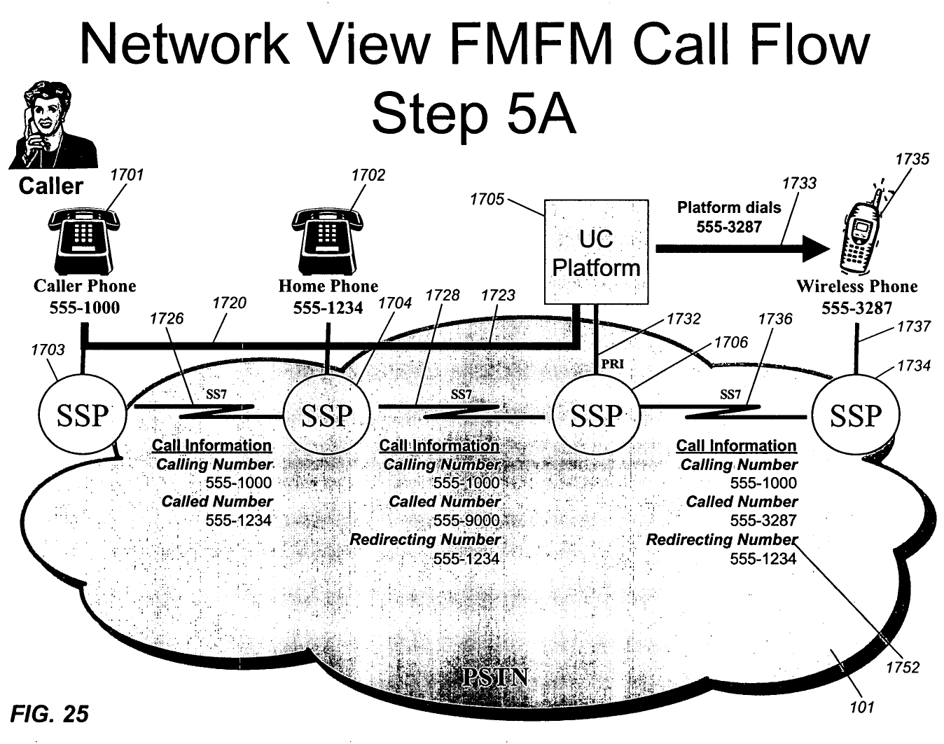

If the caller doesn't elect to go to voicemail, FMFM proceeds as shown in FIG. 25. As shown in FIG. 25, FMFM dials the first and subsequent FMFM contact numbers one at a time, sending updated call information 1752 from SSP 1706 over SS7 1736 to SSP 1734. SSP 1734 connects 1737 to wireless phone 1735. The updated calling information 1752 comprises calling number (CN) 555-1000 called number 555-3287 and RDN 555-1234.

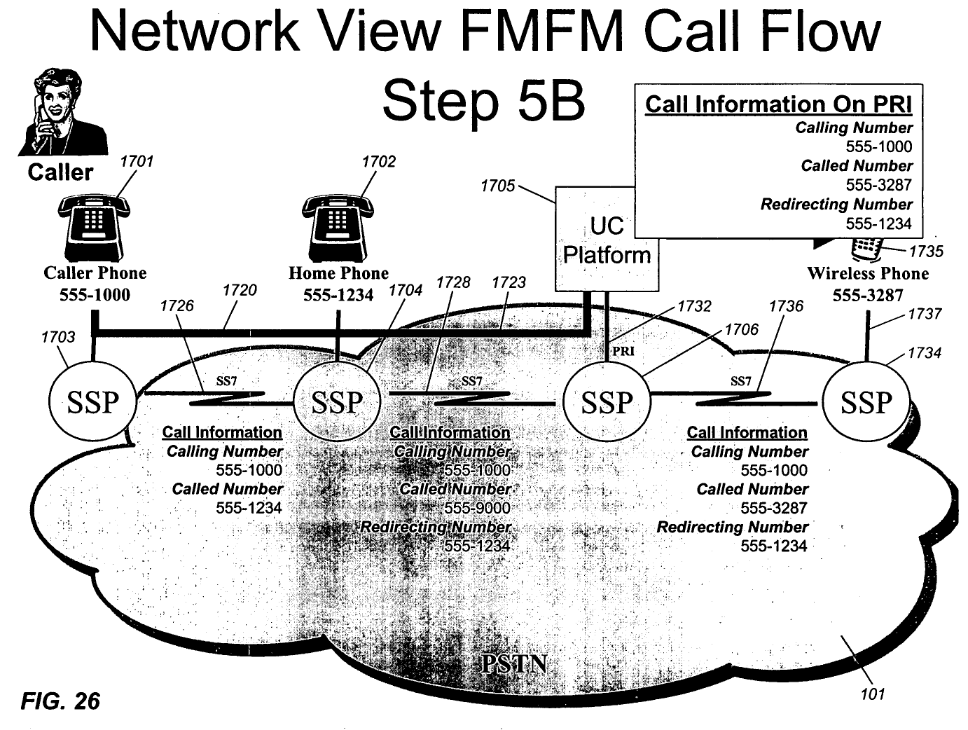

FIG. 26 illustrates the updated calling information on PRI 1737 which is used to make that out dial call. Note that when the out dial is performed, it maintains the calling number of the original call. That is, the calling number (CN) is the Caller's telephone number (555-1000), the original Called Number (Home Phone 555-1234) is given as the Redirecting Number (RDN), and the called number is the FMFM contact number represented here by the subscriber's wireless phone (555-3287). If the wireless phone is not answered, the next FMFM contact number is called until the contact number list is exhausted, the called party answers before the maximum number of rings for a called contact number or the calling party hangs up or elects to go to voicemail.

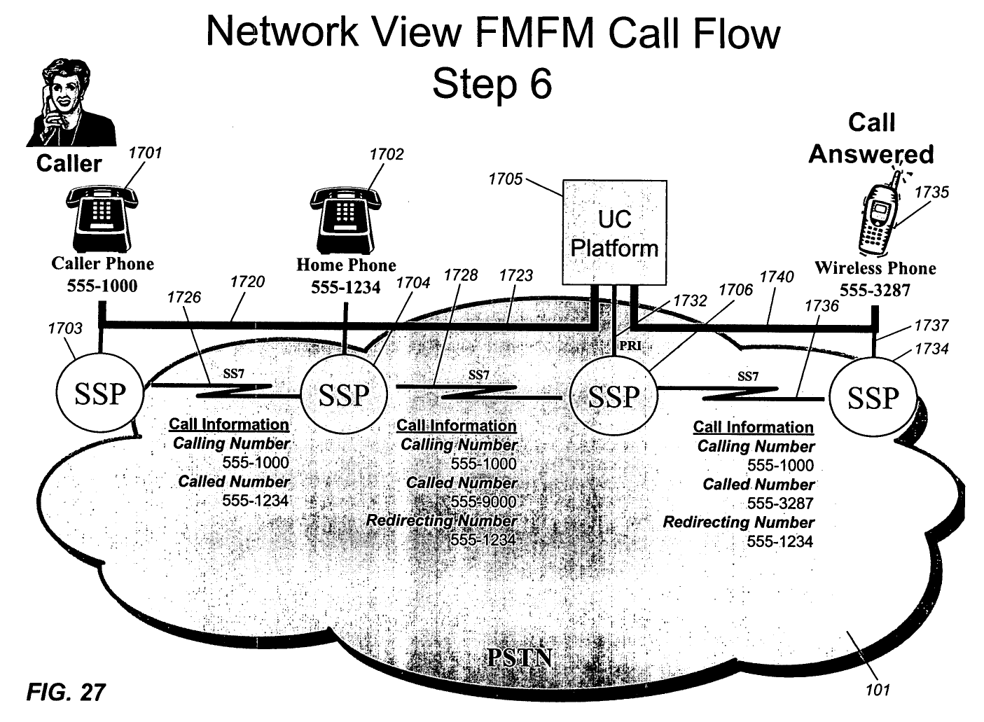

Turning now to FIG. 27, when the FMFM contact number answers (shown as the Wireless Phone 555-3287), the called party is asked to press 1 to accept the call. The called party already knows whom the call is from since the called party receives the original caller's caller identification calling information, that is, the calling party number and also, if available, the calling party name. If the called party hangs up without accepting the call the calling party is sent to voice mail. If the call is not answered, the next contact number is tried if the contact number list is not exhausted, otherwise the caller is sent to voicemail. If the called party accepts the call, the call moves on to the next step which is to connect the two calling party to the called party.

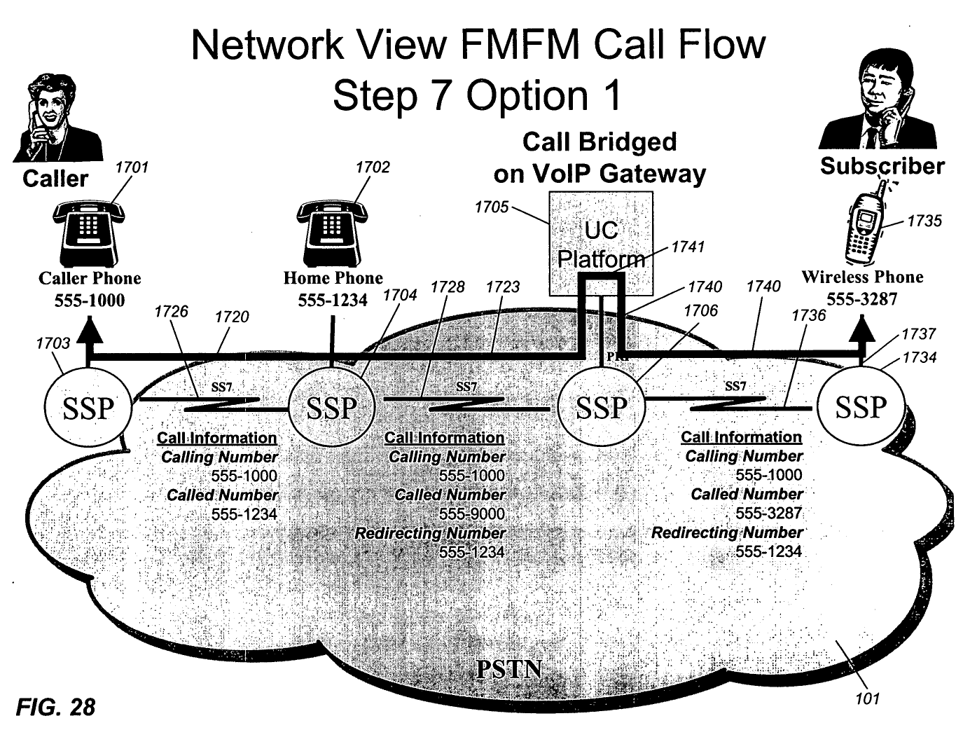

There are two methods to use to connect the called party to the calling party. The first method shown in the FIG. 28 is to connect 1741 the inbound call leg 1723 to the outbound call leg 1732 within the UC platform 1705 Voice over IP (VoIP) gateways. The advantage to this approach is that it doesn't require any additional development work. This ties up both an inbound and an outbound phone line on the UC platform for the duration of the call.

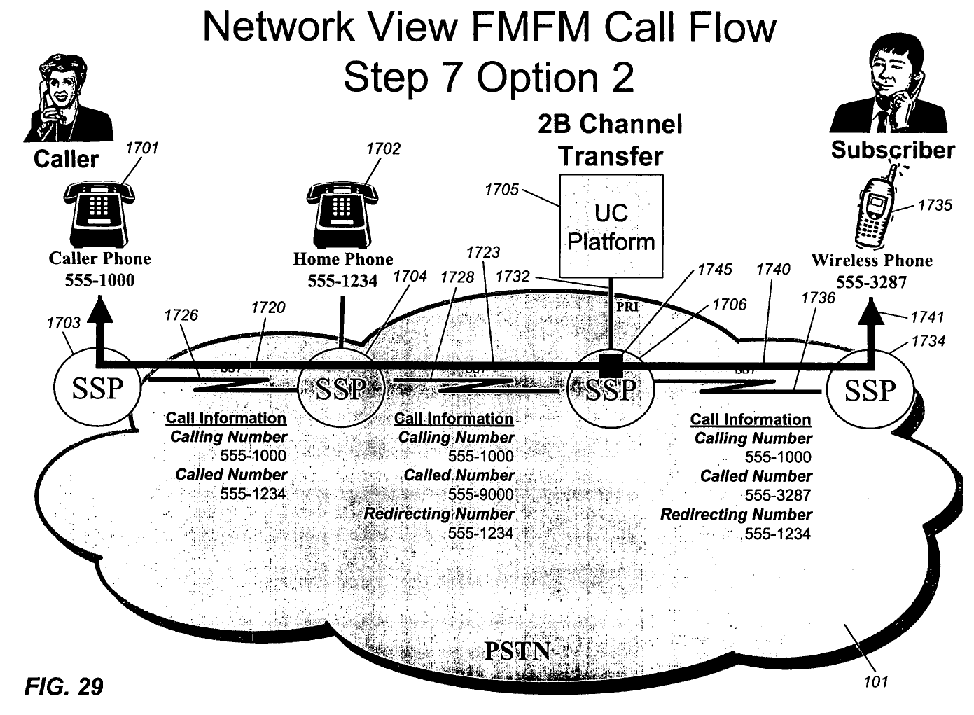

The second method shown in FIG. 29 uses 2B Channel transfer 1745 on the local serving office SSP providing PRI service to the platform's VoIP gateway. After either, the called party or calling party hangS up, all legs of the call are torn down.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a computer readable medium, a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission and public telephone networks represent examples of the state of the art. Such standards are periodically superseded by faster or more efficient equivalents having essentially the same functions. Accordingly, replacement standards and protocols having the same functions are considered equivalents.

What is claimed is:

1. A method for providing a follow-me-find-me (FMFM) telephone service in response to an inbound call according to FMFM settings associated with a sub mailbox, comprising:
assigning a plurality of sub mailboxes to a subscriber telephone number, at least one sub mailbox in said plurality of sub mailboxes containing at least one FMFM setting;
receiving an inbound call from a calling party including a called party telephone number matching the subscriber telephone number;
selecting the at least one sub mail box for processing the inbound call; and
providing the FMFM telephone service in accordance with the at least one FMFM setting contained in the selected at least one sub mailbox.

2. The method of claim 1, wherein the at least one FMFM setting comprises at least one contact number, the method further comprising:
calling the at least one contact number.

3. The method of claim 2, further comprising:
receiving a calling number associated with the inbound call; and
skipping the at least one contact number if the at least one contact number is the same number as the calling number associated with the inbound call.

4. The method of claim 2, further comprising:
receiving a redirecting number associated with the inbound call; and
skipping the at least one contact number if the at least one contact number is the same number as the redirecting number associated with the inbound call.

5. The method of claim 1, wherein the at least one FMFM setting comprises a list of contact numbers, the method further comprising:
calling contact numbers in the list of contact numbers until reaching the end of the list or a called contact number is answered.

6. The method of claim 5, further comprising:
skipping any contact number in the list of contact numbers that has already been called.

7. The method of claim 1, further comprising:
receiving a calling number associated with the inbound call at a subscriber telephone;
inserting the calling number associated with the inbound call as a calling number in a call information associated with calling the contact number; and
calling the contact number with the call information associated with the contact number.

8. The method of claim 2, further comprising:
bridging the inbound call and the call to the contact number in a voice over Internet protocol telephone system.

9. The method of claim 2, further comprising:
bridging the inbound call and the call to the contact number in a public switched telephone network.

10. A method for providing call path duplication for forwarding an inbound call to a call forwarding number in a telephone system comprising:
receiving the inbound call from a calling party including a calling party number associated with the inbound call;
inserting the calling number associated with the inbound call as a calling number in a call information associated with the call; and
providing call path duplication by forwarding the call information to the call forwarding number.

11. The method of claim 10, further comprising:
forwarding the inbound call to the call forwarding number.

12. A method for providing a call forwarding telephone service to a subscriber in response to an inbound call comprising:
receiving a call information associated with the inbound call comprising at least a calling party number and a called party number, the called party number associated with the subscriber;
retrieving at least one contact number from a database associated with the subscriber;
determining if the at least one contact number is the same number as the calling party number;
skipping the at least one contact number if the at least one contact number is the same number as the calling party number; and
calling the contact number if the at least one contact number is not the same number as the calling party number.

13. A method for providing a call forwarding telephone service to a subscriber in response to an inbound call comprising:
receiving a call information associated with the inbound call comprising at least a calling party number and a called party number, the called party number associated with the subscriber;
retrieving at least one contact number from a database associated with the subscriber;
determining if the at least one contact number is the same number as the redirecting number;
skipping the at least one contact number if the at least one contact number is the same number as the redirecting number; and
calling the contact number if the at least one contact number is not the same number as the redirecting number.

14. A telecommunications system for forwarding an inbound call associated with a subscriber to a contact number comprising:
a database for storing a plurality of sub mailboxes associated with the subscriber, at least one of the sub mailboxes containing the contact number;
a first switch for receiving the inbound call associated with the subscriber;
a server for retrieving the contact number from the at least one sub mailbox; and
a second switch for forwarding the inbound call to the contact number from the at least one sub mailbox.

15. The system of claim 14, further comprising:
a component for skipping the contact number if the contact number is a calling number or redirecting number in the inbound call.

16. The system of claim 14, further comprising:
a component for inserting a calling number associated with the inbound call into a calling information as a calling number associated with the call forwarded to the contact number.

17. A telecommunications system for forwarding an inbound call associated with a subscriber to a contact number comprising:
a database storing a contact number associated with the subscriber;
a switch for receiving the inbound call associated with the subscriber and an inbound call information associated with the inbound call comprising at least a called number, and at least one of a calling number and a redirecting number, the called number associated with the subscriber;
a server for retrieving the contact number from the database; and
a switch for calling the contact number if the contact number is not a calling number or a redirecting number in the inbound call information.

18. The system of claim 17, further comprising:
a component for inserting a calling number associated with the inbound call into a calling information as a calling number associated with the call forwarded to the contact number.

19. A telecommunications system for forwarding an inbound call associated with a subscriber to a call forwarding telephone number comprising:
a switch for receiving the inbound call and a call information associated with the inbound call, the call information associated with the inbound call comprising at least a calling number for the inbound call;
a call information for an outbound call comprising at least a calling number associated with the outbound call;
an insertion component for inserting the calling number associated with the inbound call as the calling number in the call information associated with the outbound call; and
a switch for calling the call forwarding number with the outbound call information.

20. The system of claim 19, further comprising:
a component for skipping the outbound call if the call forwarding number is a calling number or redirecting number in the inbound call.

21. A computer readable medium containing instructions that when executed by a computer perform a method for providing a follow-me-find-me (FMFM) telephone service in response to an inbound call according to FMFM settings associated with a sub mailbox, comprising:
assigning a plurality of sub mailboxes to a subscriber telephone number, at least one sub mailbox in said plurality of sub mailboxes, containing at least one FMFM setting;
receiving an inbound call from a calling party including a called party telephone number matching the subscriber telephone number;
selecting the at least one sub mail box for processing the inbound call; and
providing the FMFM telephone service in accordance with the at least one FMFM setting contained in the selected at least one sub mailbox.

22. The medium of claim 21, wherein the at least one FMFM setting comprises at least one contact number, the method further comprising:
calling the at least one contact number.

23. A computer readable medium containing instructions that when executed by a computer perform a method for providing a call forwarding telephone service to a subscriber in response to an inbound call comprising:
receiving information associated with the inbound call said information comprising at least a calling party number and a called party number, the called party number associated with the subscriber;
retrieving at least one contact number from a database associated with subscriber;
determining if the at least one contact number is the same number as the calling party number;
skipping the at least one contact number if the at least one contact number is the same number as the calling party number; and
calling the contact number if the at least one contact number is not the same number as the calling party number.

24. A computer readable medium containing instructions that when executed by a computer performs a method for providing a call forwarding telephone service to a subscriber in response to an inbound call comprising:
receiving a call information associated with the inbound call comprising at least a redirecting number;
retrieving at least one contact number from a database associated with the subscriber;
determining if the at least one contact number is the same number as the redirecting number;
skipping the at least one contact number if the at least one contact number is the same number as the redirecting number; and
calling the contact number if the at least one contact number is not the same number as the redirecting number.
